(19) United States
(12) Patent Application Publication
(10) Pub. No.: US 2013/0299606 A1
(43) Pub. Date: Nov. 14, 2013

(54) TEMPORARY PROTECTION DEVICE FOR AN IN GROUND IRRIGATION SYSTEM

(71) Applicants: Radford Smith Bishop, Marengo, OH (US); Radford James Bishop, Marengo, OH (US)

(72) Inventors: Radford Smith Bishop, Marengo, OH (US); Radford James Bishop, Marengo, OH (US)

(21) Appl. No.: 13/667,432

(22) Filed: Nov. 2, 2012

Related U.S. Application Data
(60) Provisional application No. 61/556,036, filed on Nov. 4, 2011.

(51) Int. Cl. B05B 15/00

(52) U.S. Cl. CPC B05B 15/001
USPC 239/288.5; 239/288.3

(57) ABSTRACT

A temporary protective device for a sprinkler head connected to an in-ground irrigation system comprising a cover with a generally flat bottom, the cover comprising one or more receiver holes, the receiver holes accepting a removable key, the key anchoring the cover over the sprinkler head and extending into the ground below the receiver hole. Alternatively, the keys may be attached to the bottom of the cover. The keys and or the cover may be made of a biodegradable material.

### FIELD OF THE INVENTION

The present invention relates generally to protection of in-ground irrigation sprinkler heads and specifically to a temporary protective device for sprinkler heads and associated components incorporated in an in-ground irrigation system.

### BACKGROUND OF THE INVENTION

Irrigation systems for both residential and commercial properties are necessary to provide needed watering of the turf as well as landscape plant material. The typical irrigation system is comprised of several components that are located in the soil in turf and landscape bed environments. These components are easily damaged by the use of aeration type equipment. In a typical irrigation installation there are sprinkler heads and associated components. An example of an associated component would be valve body lids, which cover underground canisters or boxes housing electrical wiring, water valve solenoids and the like. These components could be severely damaged by an aeration tine breaking through the weak removable lid and entering the mechanical enclosure. Both sprinkler heads and valve canisters are mostly buried in the ground with only there upper surface being at ground level. This makes the sprinkler heads and components easily damaged by soil penetrating aeration tines. The present invention provides temporary protection to allow aeration services to be performed and greatly reduce their potential to damage irrigation heads and components. Removal of the temporary protective device is recommended immediately after aeration service is performed. A typical sprinkler head is constructed of a plastic outer housing which connects to an underground water line, with a twist in mechanical sprinkler assembly that is inserted down into the outer plastic housing. These sprinkler assemblies are not intended to nor do they have the structural stability to withstand impact from aeration type equipment. In the event that they are struck by an aeration tine they would most likely suffer severe damage and need to be replaced.

It would be beneficial to find a better way to protect in-ground sprinkler heads.

### SUMMARY OF THE INVENTION

A temporary protective device for sprinkler heads/irrigation system components. To be placed above in ground irrigation components that are partially buried in the ground. These devices would be used for temporary protection of the irrigation system components from potential physical damages. The temporary protective device would not be installed while the irrigation system is in operation mode. To be used as a protective device and could be removed immediately after services are completed. Such as turf aeration or other potentially damaging activities. The temporary protective device has no center aperture for a sprinkler head to extend through. The temporary protective device could be of any shape and not limited to round or rectangular. The device having a flat or generally flat base with one or more receiver holes allows it to accept keys/spikes or other mounting methods for the purpose of anchoring it to the ground. These devices could be made of a bright florescent safety color with a location flag for the purpose of seeing them well in advance and also aiding in the reassurance that devices would not be left on the property after services are completed. Device could be anchored to the ground by means of but not limited to releasable biodegradable spikes designed to either release or sheer when predetermined stress or pressure is applied.

Our present invention is designed to withstand the impact of aeration tines and provide a temporary protective device to shield the fragile sprinkler heads and components, which will reduce the possibility that they will be struck by an aeration tine in the process of performing a service. The temporary protective device with no center aperture is designed to be struck by an aerator tine or associated hazard and provide a barrier to shield the component it is responsible for protecting.

The protective device could be but is not limited to a domed or flat or generally flat construction, with no center aperture. To lay flat or generally flat on the ground unsecured or be held in place by at least one spike that engages the soil and are positioned on the underside of the device to anchor it to the ground. This anchoring could be accomplished by nailing or spiking/having spikes molded into body assembly/frictionally engaged/solid spikes/sheerable or non-sheerable biodegradable spikes/attached by fasteners/insert and twist to lock. These methods could be accomplished with either solid and or biodegradable materials. This device is to be applied prior to the use of turf aeration equipment or any other equipment or service that could benefit from its protection, and to be removed prior to the operation on the irrigation system.

Method of mounting anchors could be but are not limited to the following:

Spikes molded into the device itself.

Spikes Glued/adhered with adhesive semi-permanent mounting

Spikes that are frictionally in engaged.

Spikes that are threaded that will screw into the actually body of the protective device.

Spikes that are held on by fasteners.

Spikes/nails that are driven into the ground by a hammer.

Key/Spike could insert into receiver and twist to lock.

Key/Spikes could slide into a keyway that would be located on the lower side of the device.

All of these associated ways of connecting the spike to the protective device can be either made of but not limited to solid high impact plastic/metal or can be made out of but not limited to a biodegradable material. They also will have but not limited to the ability to have built in sheer points that will allow the spike to break when put under a pre-determined amount of pressure/stress/force.

The present invention provides, but not limited to, a solid or hollow or semi-solid (gusseted, ribbed or liquid filled) temporary protective device for sprinkler heads and associated irrigation system components. The temporary protective device could be of any shape and is not limited to round or rectangular. The Temporary protective device is applied to the ground above irrigation heads and or components prior to aeration services or any service/activity that would pose a physical threat to irrigation components. The devices surface can be, but not limited to, smooth/textured/or incorporate designs.

The device has one or more keys/spikes that have various ways of being fastened to the device. The keys can enter from any direction. Including but not limited to the first method which is that they can be molding into the device itself. A second method is the key being friction fit into recesses in the bottom of the device. The third is held on by fasteners that secure them to the device. A fourth possibility would be nailing through an opening/openings in the device by a hammer spiking, them to the ground. A fifth possibility would be to adhere the spikes with glue/adhesive/other fastening means for semi-permanent placement, either into the receiving holes or directly onto the flat or generally flat body of the device. A sixth is to have them threaded so that they will screw into the bottom of the device into threaded recesses. A seventh would be to have the spikes slide into keyways on the lower outside area of the device, sliding in from the outside toward the center of the device or sliding out from the center to the outside of the device.

The keys/spikes can be either but not limited to solid or made of a biodegradable material that has adequate strength to perform its duties. The keys/spikes that are built of a biodegradable material that has adequate strength and stability when engaged into the soil to hold the protective device in place over the irrigation head/irrigation components that it is designed to protect. Keys/spikes/nails and above mentioned methods could be manufactured with a sheer point which in the event that the device does come in contact with an aeration tine/other hazards and slid horizontally across the surface of the ground they will either sheer off in their imbedded location in the soil or they will sheer off when meeting resistance from the irrigation head/component they are responsible for protecting. On The underside center of the device is recessed indentation with tapered sidewalls tapered in such a fashion that allows the device to slide up and over the irrigation head/component if impacted and slid horizontally by an aeration tine/other hazard. (This indentation does not extend through the thickness of the device.) (The device could also be manufactured without any indentation on the underside of the flat or generally flat bottom.) In either case the key/spike would not have the stability characteristics to severely damage an irrigation head/component. When temporary protective device is impacted by an aeration tine it is designed to transfer and distribute the shock, load and force of the impact into the earth surrounding the sprinkler head or component and greatly reduce the possibility that the impact and down pressure is transferred to the sprinkler head or component which it is responsible to protecting. In the event the protective device is hit by an aeration tine/other hazard at such an angle to dislodge it from the soil and flip it upside down on the surface of the ground the anchor key would either stay embedded in its original position in the soil as the device pulls away or if the keys/spikes remain engaged in the device, there sheer characteristics and construction would pose no threat to equipment tires personnel etc.

Given that the keys/spikes could be but not limited to be constructed of a biodegradable material they will, over a period of time, if left on the property be non-threatening and degrade naturally. If the protective device pulls away from keys/spikes leaving them in their embedded position in the soil the protruding top section of the key/spike that inserts into the base of the protective device has no sharp edges and would be non-threatening to future equipment and pedestrian traffic. In the event the key/spike sheers off level with the base of the protective device and remains in its receiver in the underside of the protective device a punch out hole is provided for each keyway/spike allowing the user to simply punch out the broken key/spike easily and quickly. Keys/spikes are reusable if not weakened by environmental factors or fractures. Keys/spikes left on the surface of the ground should be collected by the user after aeration/other services have been completed and prior to mowing. In the event that a mower did contact a key/spike left on the surface it would most likely destroy it before throwing discharging it. Keys/spikes could either be but not limited to natural in color or colored a bright eyecatching color to match the device, making spikes easy to locate and collect. These protective devices could or could not have a receiver hole in the top which is partially recessed for insertion a location flag to easily be seen at a distance by an equipment operator. Its important to note this small receiver hole does not fully penetrate the thickness of the device. Its sole purpose is to receive a small location flag, not to allow the operation of a sprinkler head while protective device is in place. The device itself could be, but not limited to, molded out of a high impact plastic and could be a bright fluorescent color. The keys/spikes can be purchased separately and could have but not limited to straight or serrated cutting edges to aid them in their installation and retention characteristics when pressed into the soil.

Receiver holes in the bottom of the device could be but are not limited to rectangular, square, circular, etc. The wails of the holes could be but not limited to straight walled or tapered.

While a particular form of the invention has been illustrated and described, it will be apparent to those skilled in the art that various modifications can be made without departing from the spirit and scope of the invention.

Given that the keys/spikes insert into the receiver hole in the base of the protective device and are easily removable in the event that the protective device could not be installed over an irrigation head or component due to an object in the soil (rock etc.) preventing installation. The key impacting the object in question could simply be removed from the receptacle in the base of the protective device allowing the device to be reinstalled without resistance.

As used herein, “approximately” means within plus or minus 50% of the term it qualifies. The term “about” means between ½ and 2 times the term it qualifies.

Receiver hole/holes angle can vary to meet different requirements of the devices performance. For example, using an angle of about 95 to about 125 degrees moves the spikes away from irrigation components. A hole with an angle of about 85 to about 65 degrees moves the spikes under the device and prevents damage to the anchoring system.

The methods of the present invention can comprise, consist of, or consist essentially of the essential elements and limitations of the invention described herein, as well as any additional or optional ingredients, components, or limitations described herein or otherwise useful in compositions and methods of the general type as described herein.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

### BRIEF DESCRIPTION OF THE DRAWINGS

Title A—Drawing No. 1 Descriptions

FIG. 1 is an top view of the domed annular body that shows a cross section view in Section A-A.

FIG. 2 is a bottom view of the protective device showing the receiver holes.

FIG. 3 shows the side view allowing you to see the Key push out hole. Cross SECTION B-B illustrates the side section view of the device illustrating the Biodegradable key/spike receiver and Flag receiver.

FIG. 4 is an isometric view of the temporary protective device showing its domed top and various receivers' openings.

FIG. 5 is a top view showing the hidden lines that portrays the relationship of the irrigation head cavity.

Title A—Drawing No. 2 Descriptions

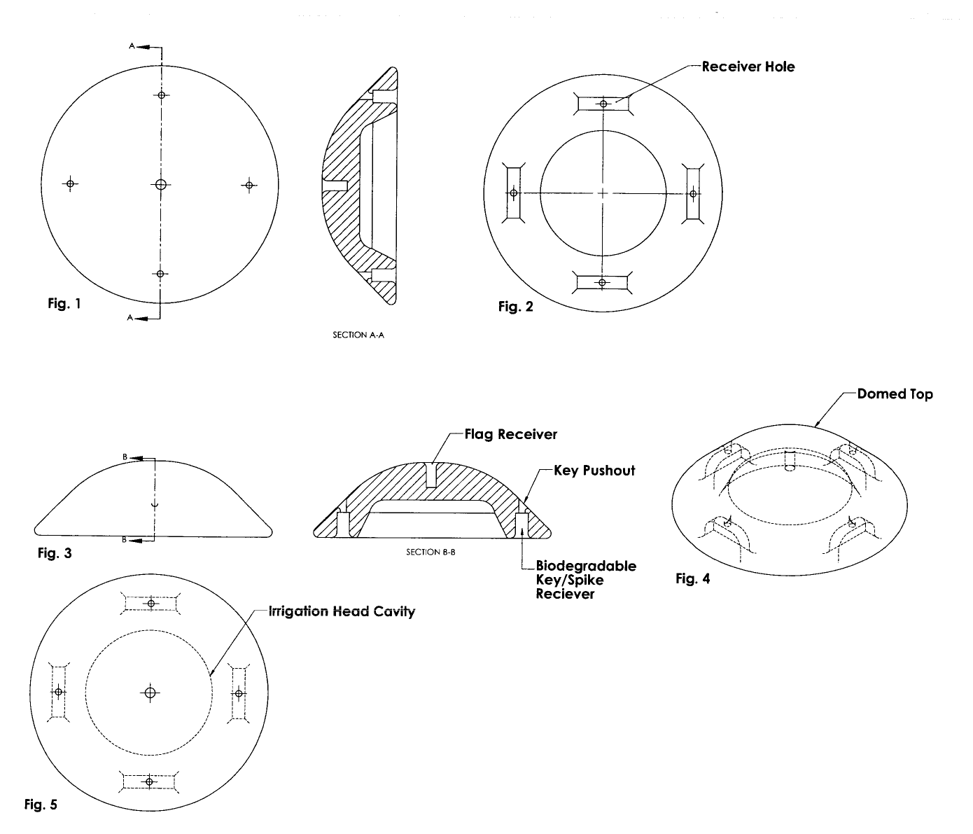

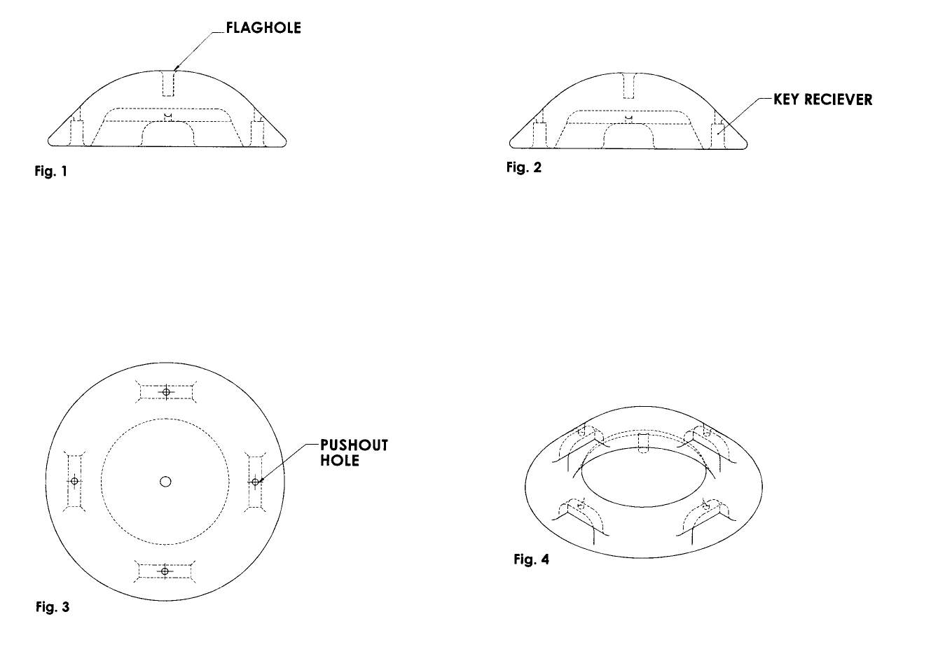

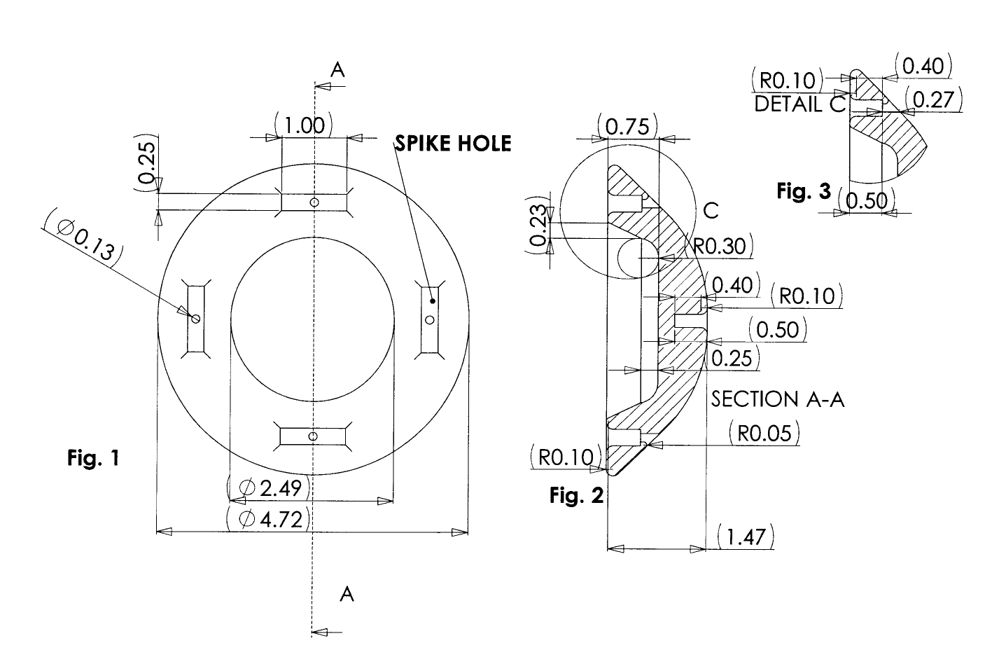

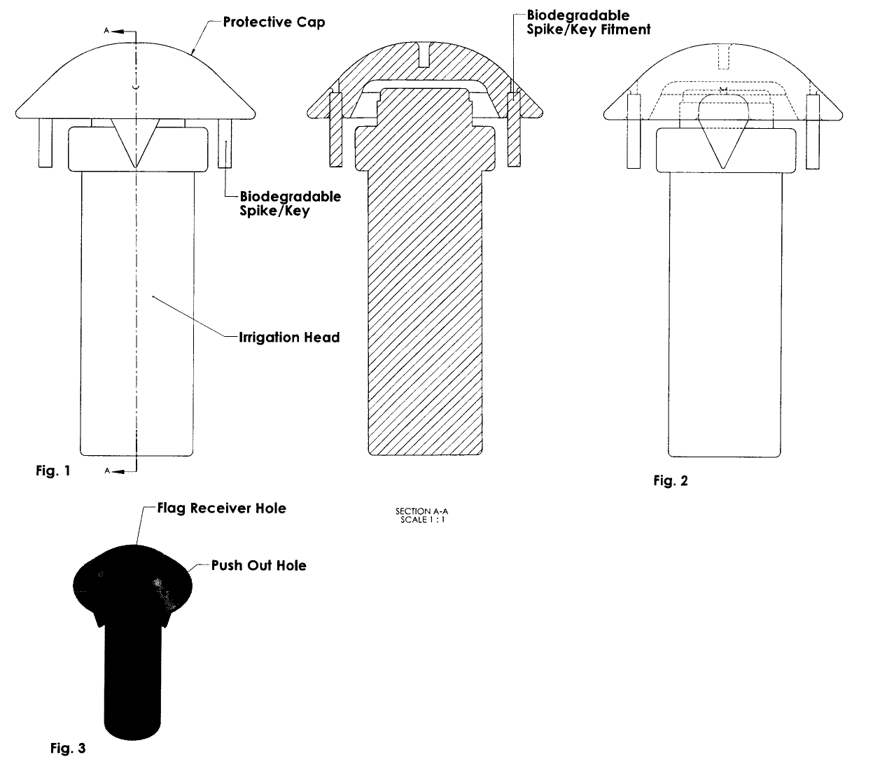

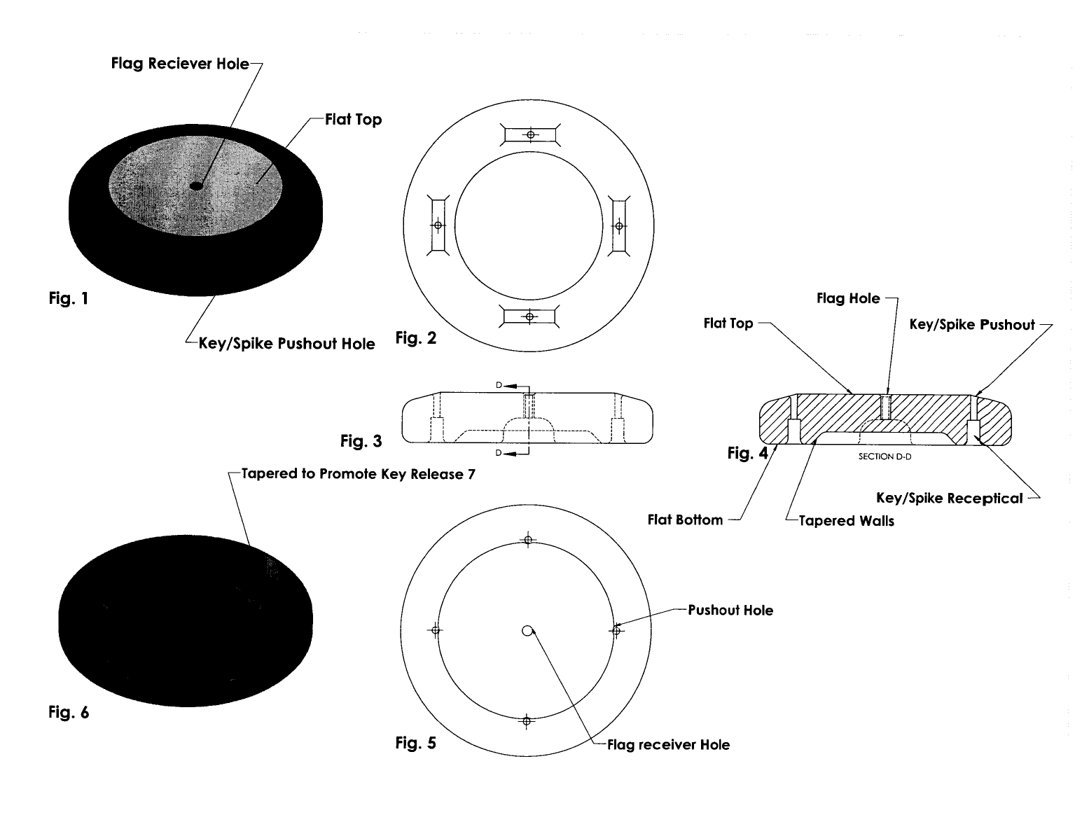

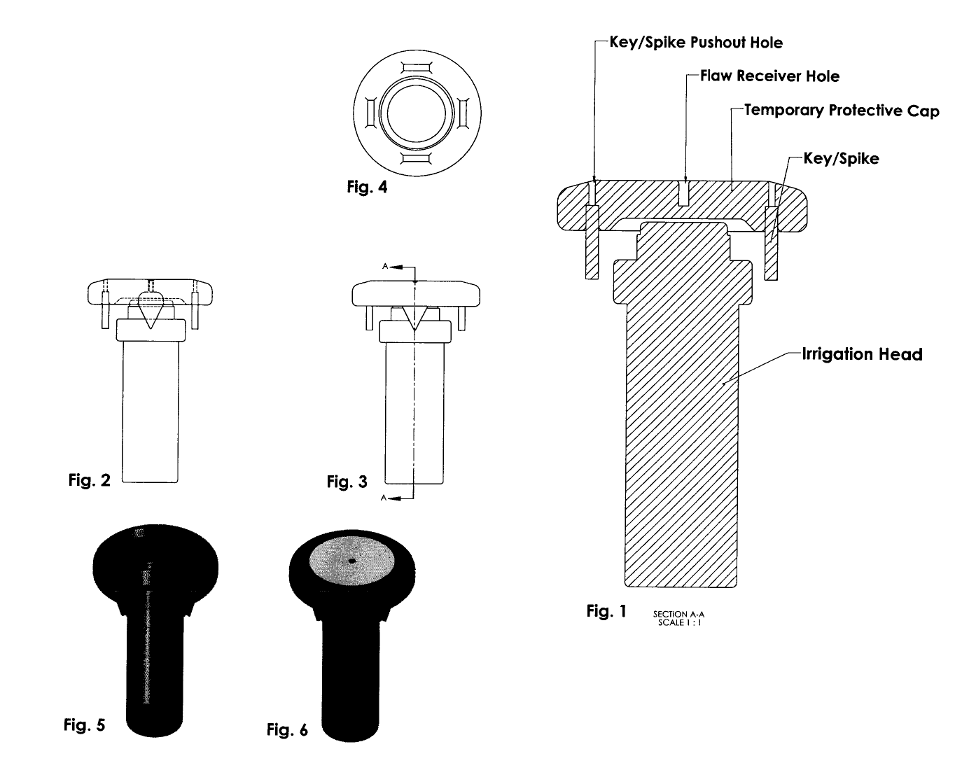

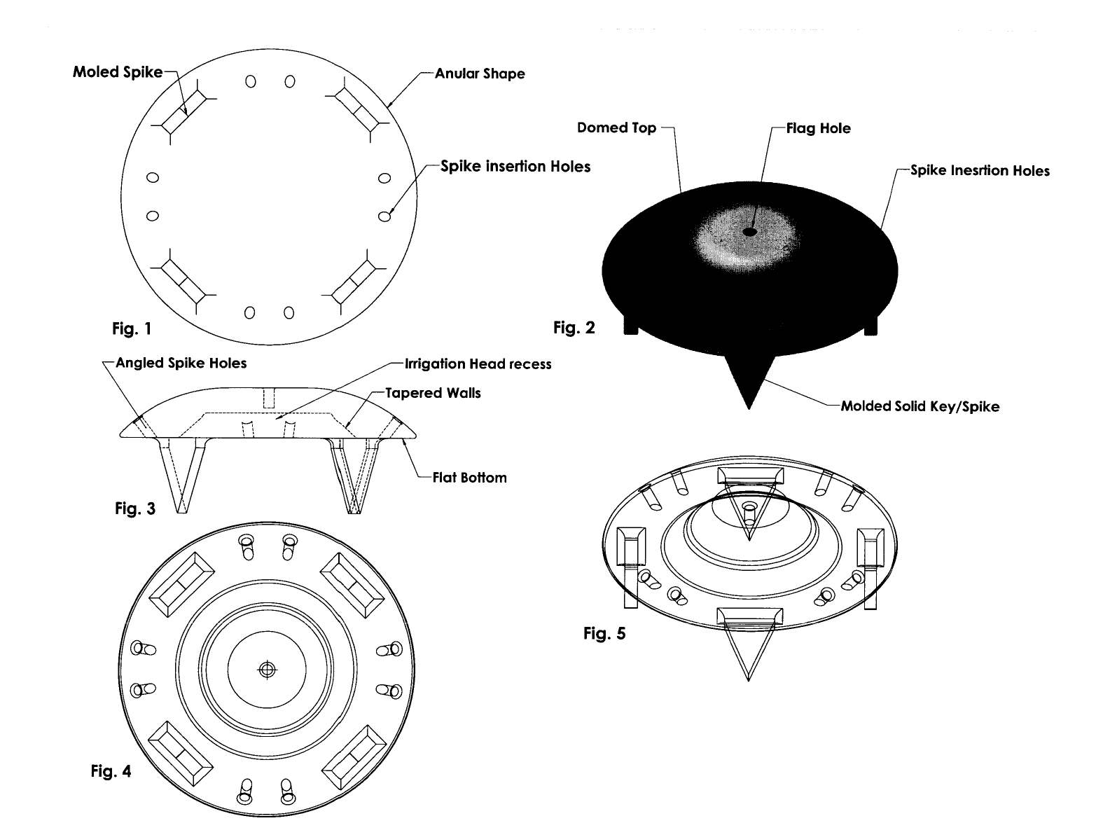

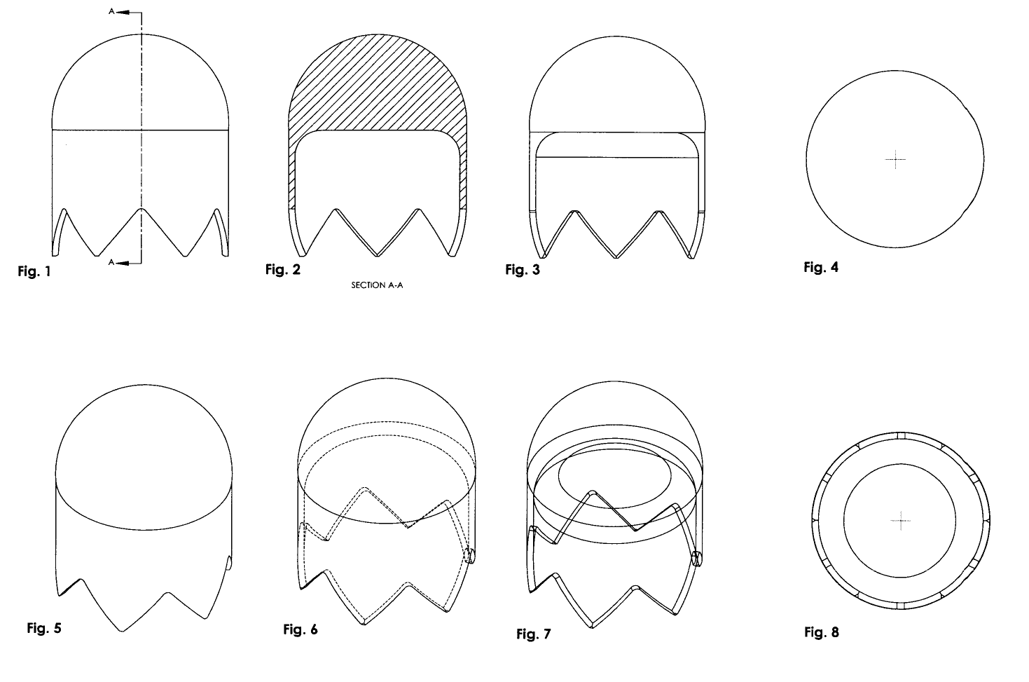

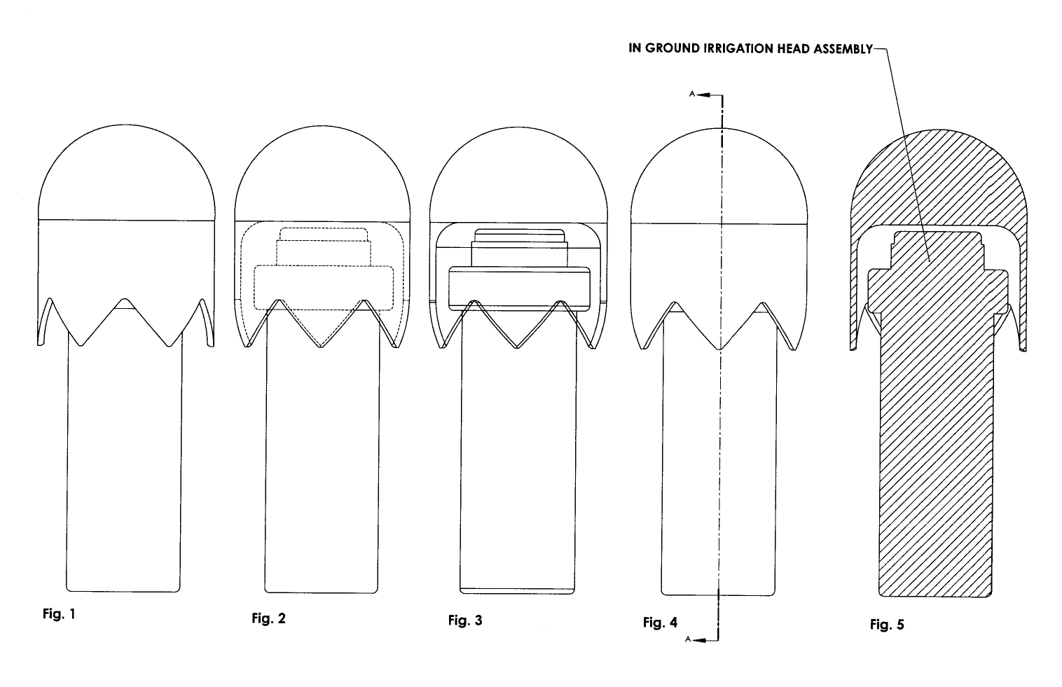

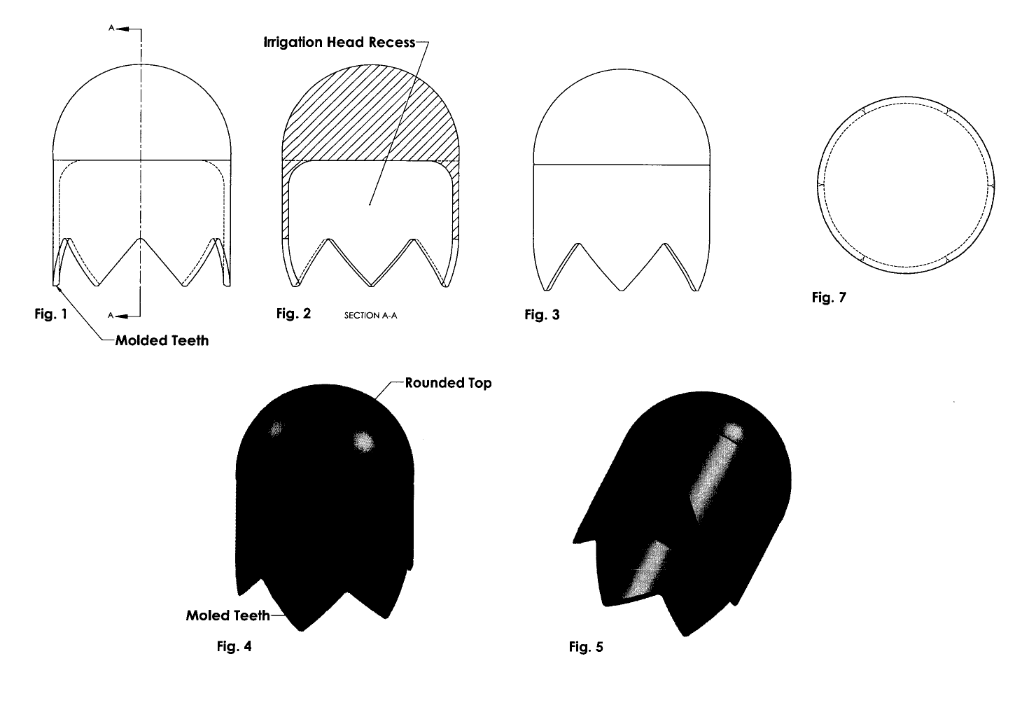

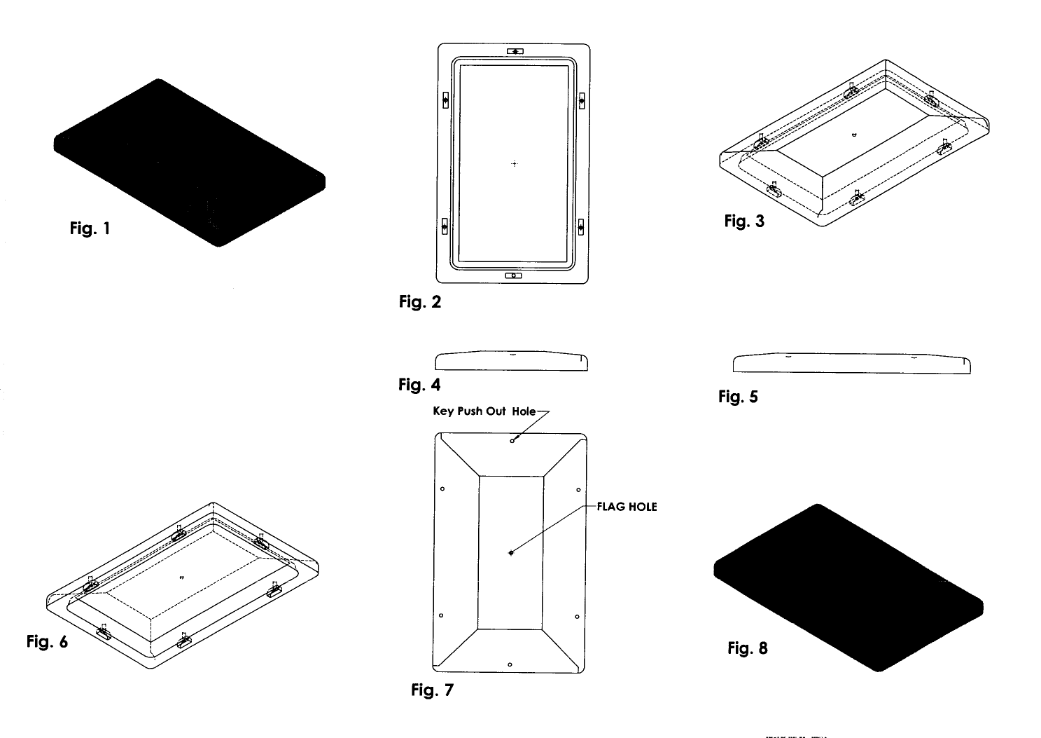

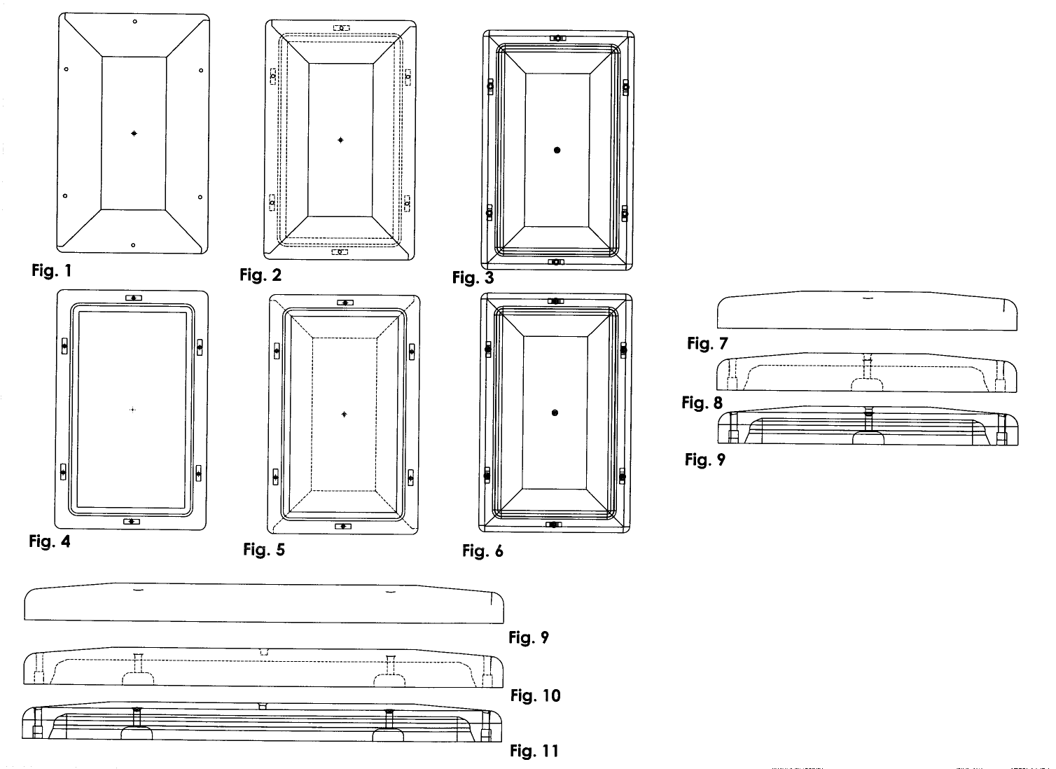

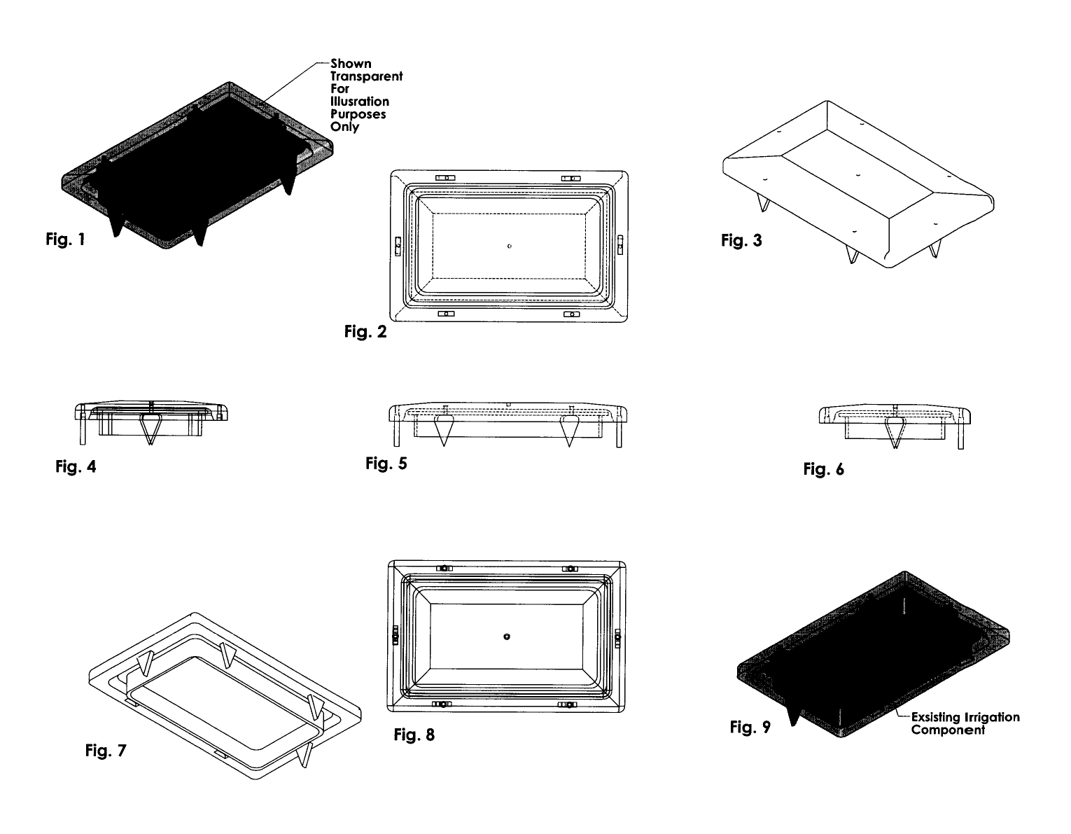

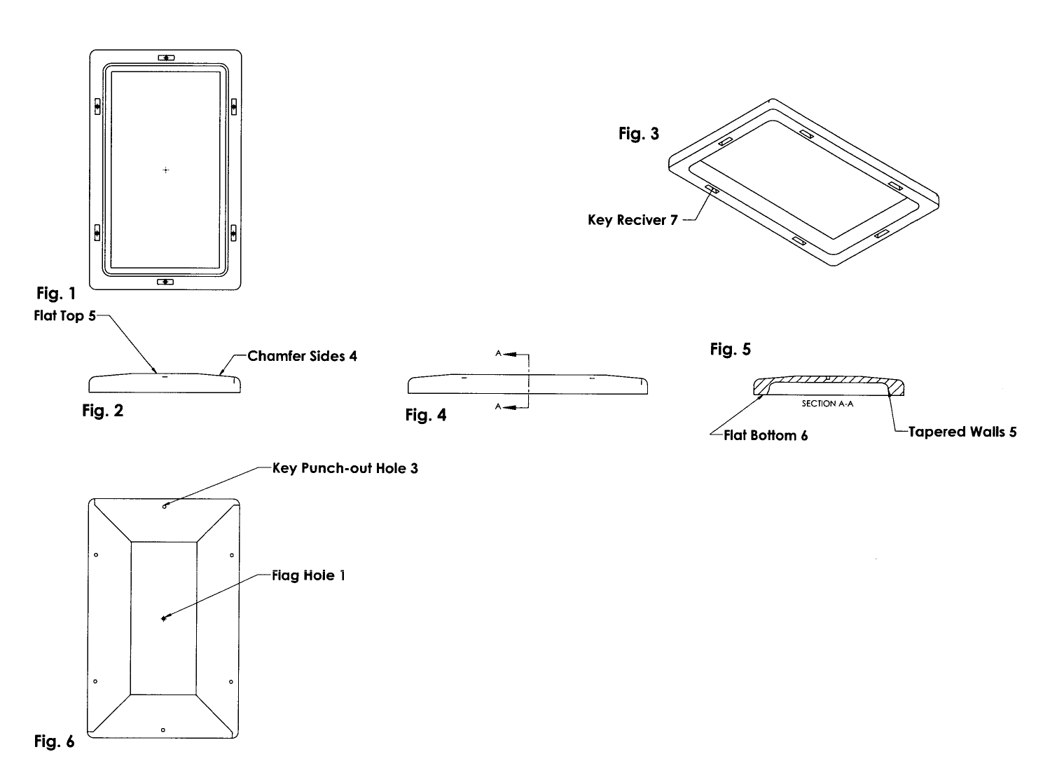

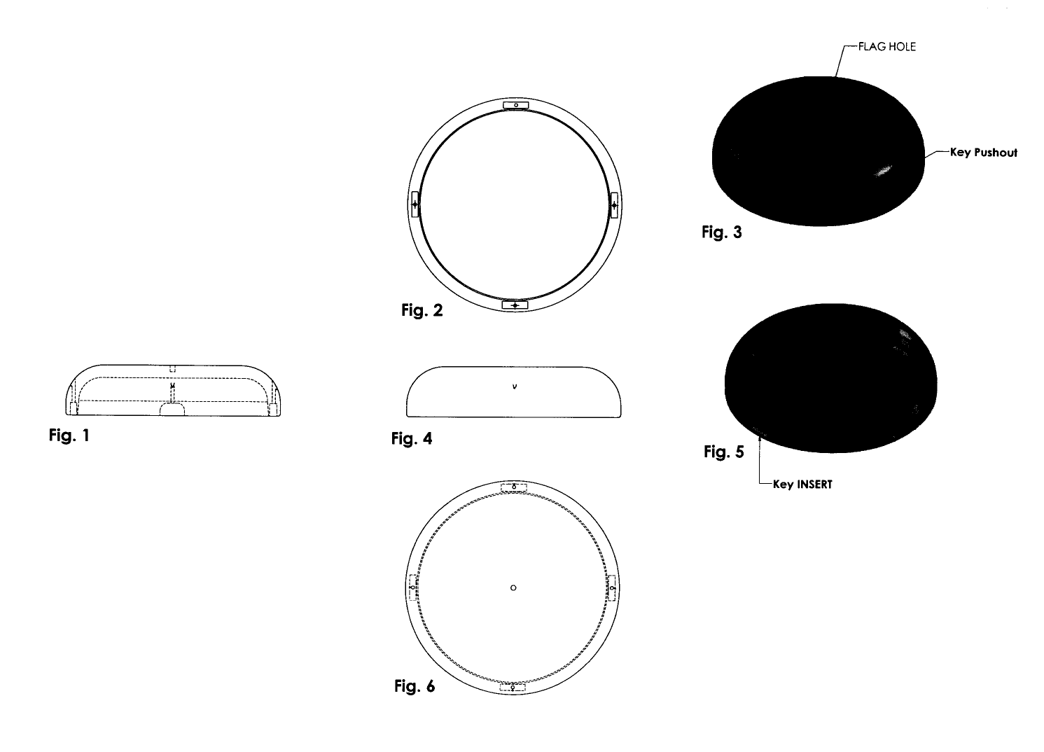

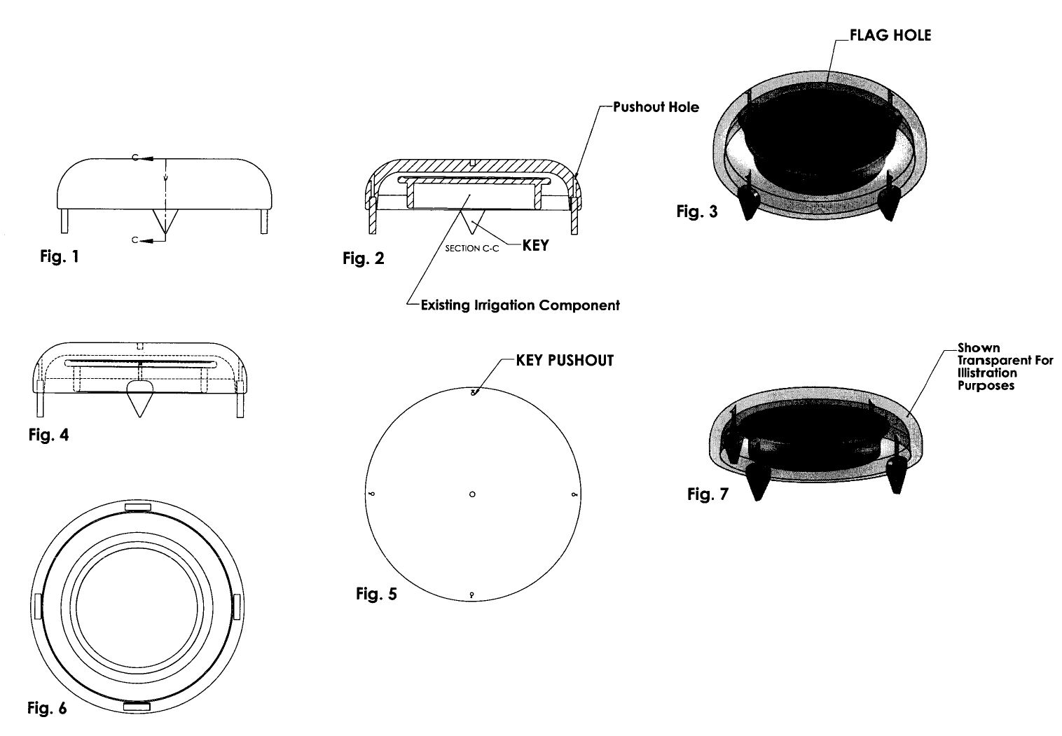

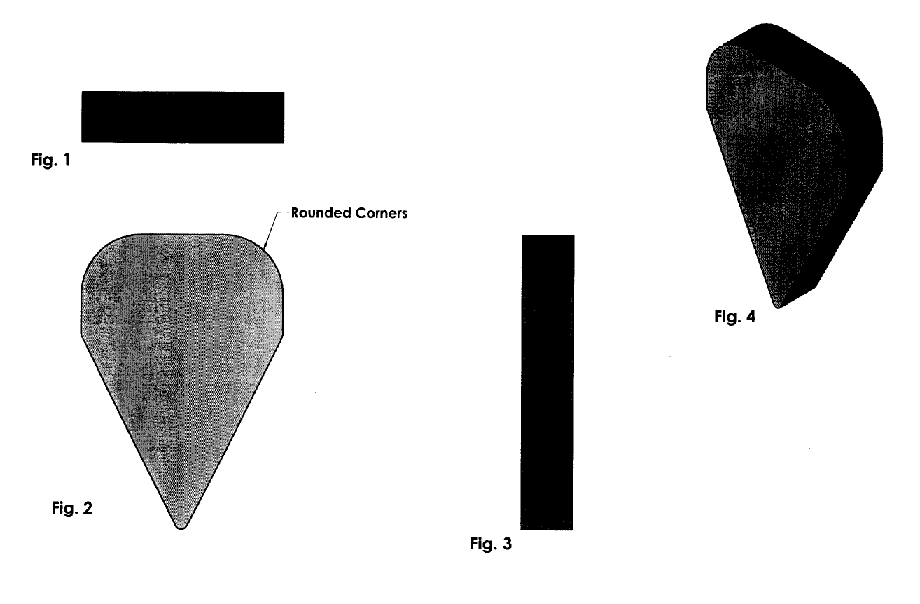

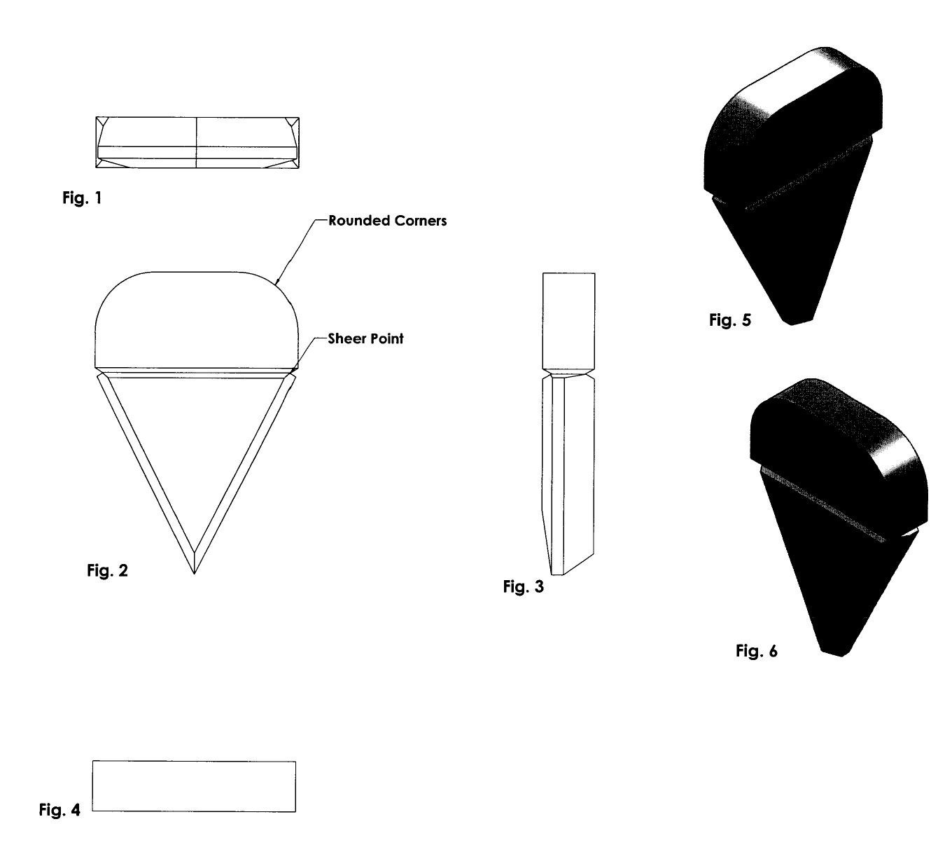

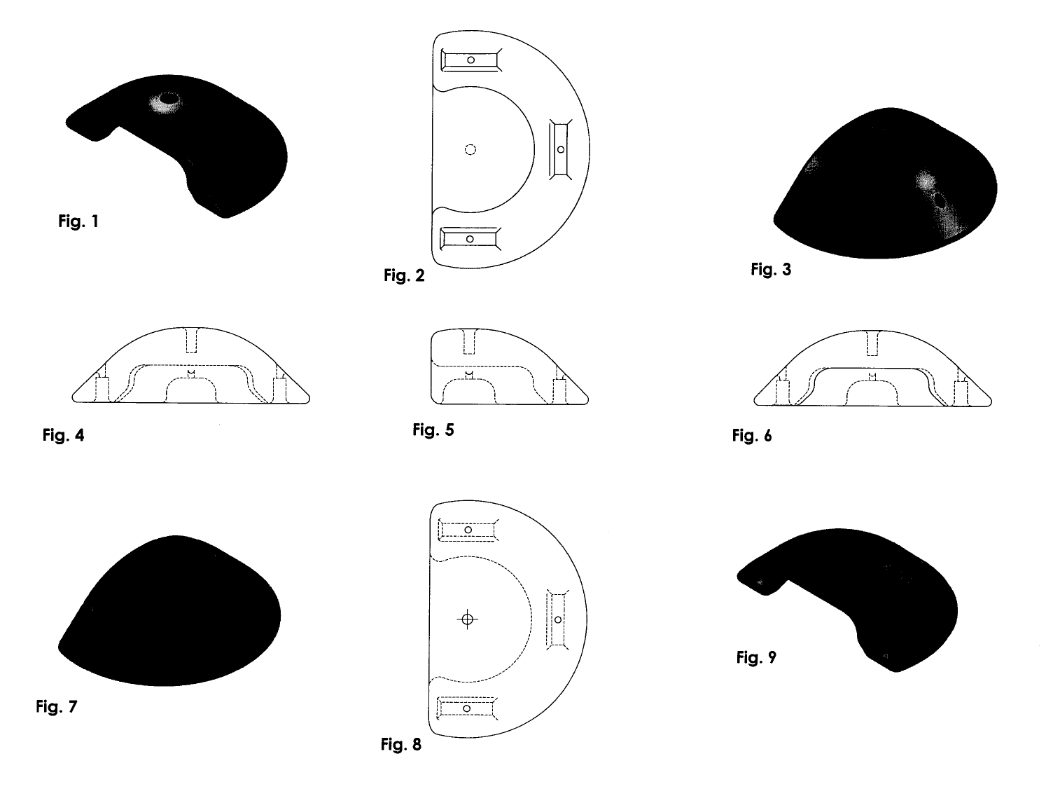

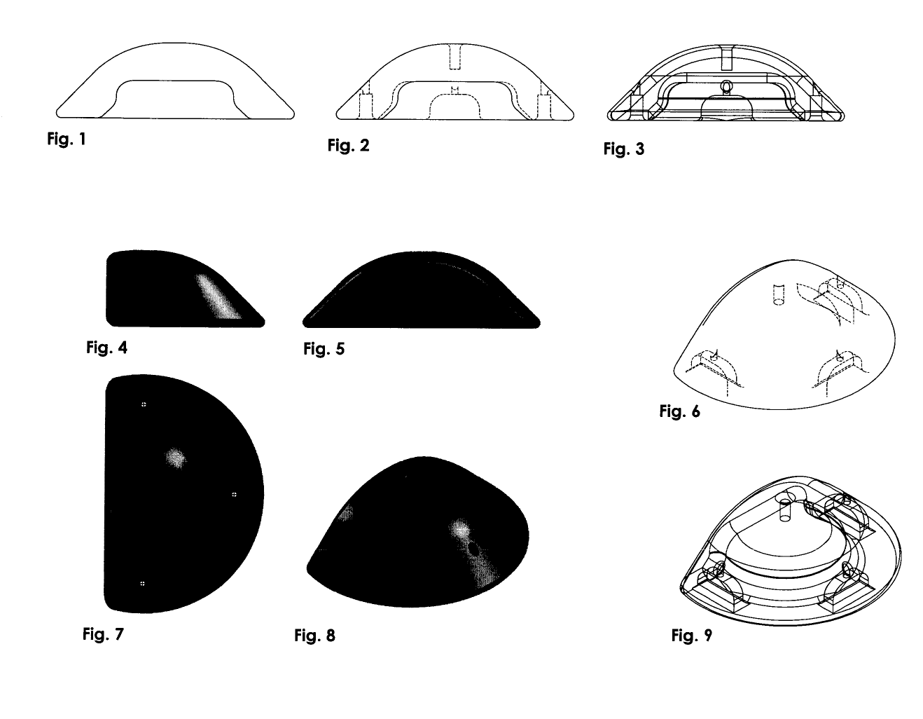

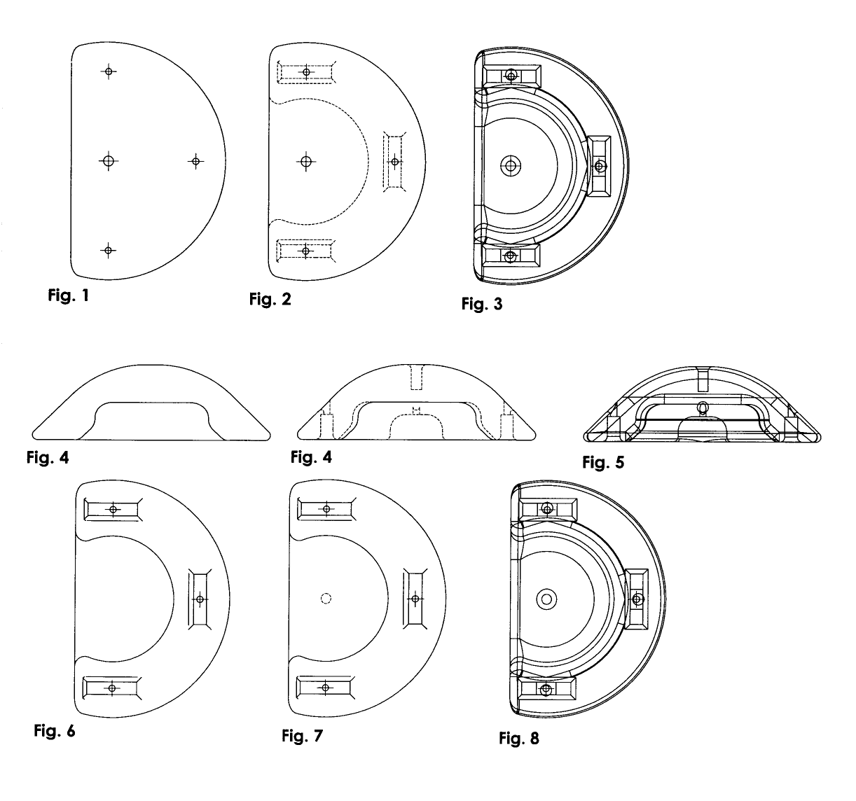

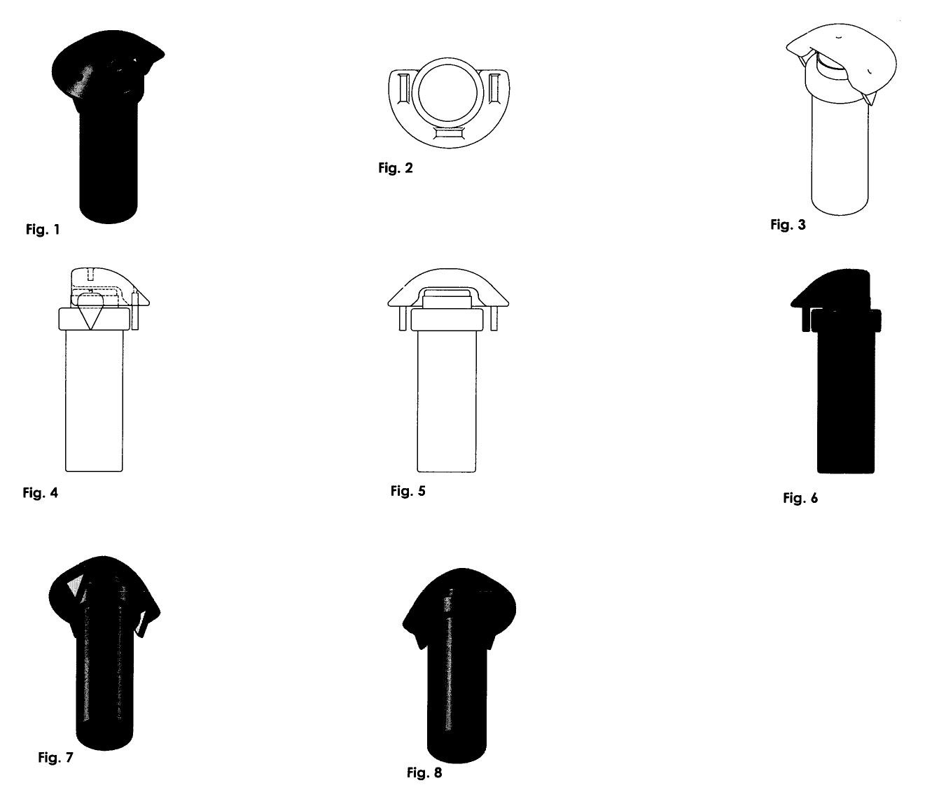

FIG. 1 & FIG. 2 are schematic side views.

FIG. 3 is a bottom view.

FIG. 4 is a perspective hidden line view.

Title A—Drawing No. 4 Descriptions

FIG. 1 is the front view of the Assembly relationships including the protective device-Biodegradable Spikes/Keys-Irrigation Head. Cross Section A:A shows the head being protected by the temporary device, also portrays the Biodegradable Key/Spikes relationship with the Irrigation head and the Device.

FIG. 2 gives the hidden line view of the assembly allowing the fitment and relationship of all components shown.

FIG. 3 is an isometric view of the assembly showing the optional fluorescent safety color. Also shown is the push out holes and flag receiver hole.

Title B—Drawing No. 1 Descriptions

FIG. 1 shows an isometric view of the temporary protective devices annular body, also shows the devices flat top, Biodegradable Spike/Key Push out hole and flag receiver hole.

FIG. 2 illustrates the bottom view of the device showing the Key/Spike receiver holes.

FIG. 3 is a side view with the hidden lines shown to portray the relationships of the associated aspects of the device.

FIG. 4 (SECTION D:D) is a cross section view of FIG. 3 that labels the various different features unique to the device.

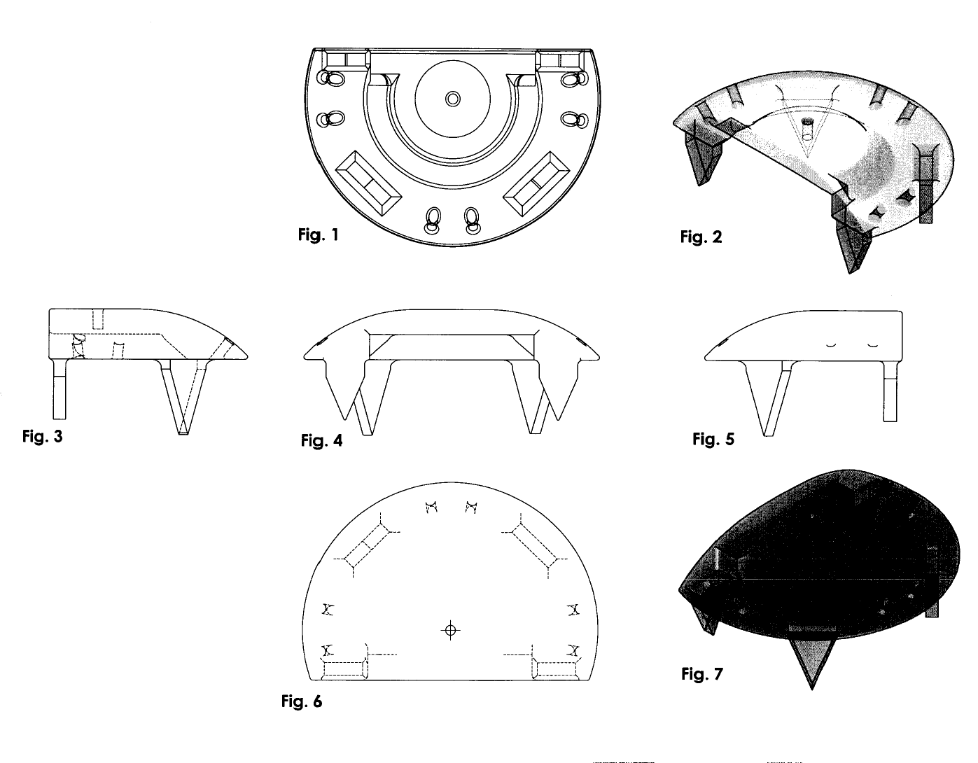

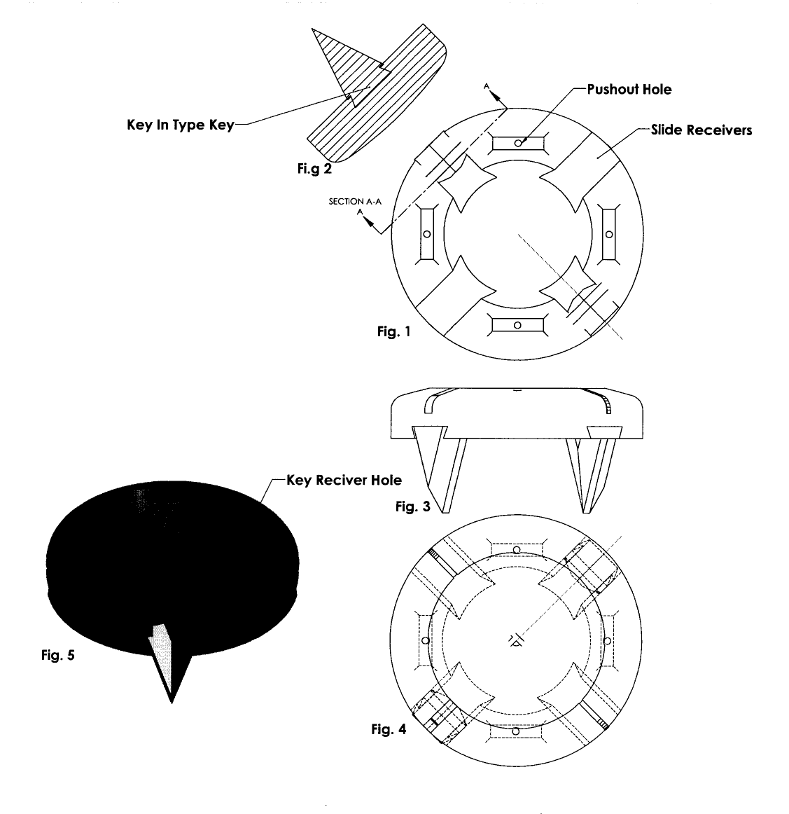

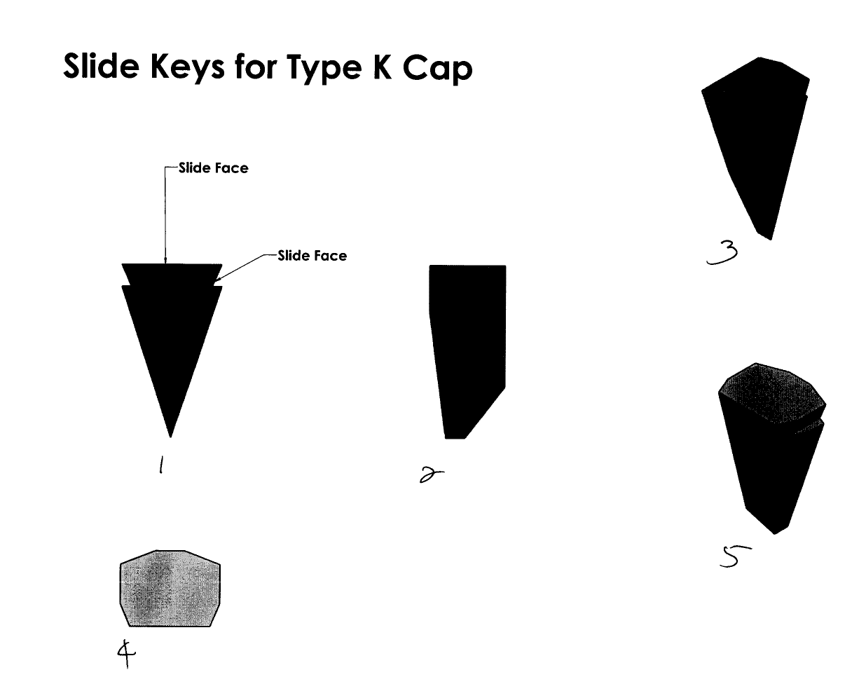

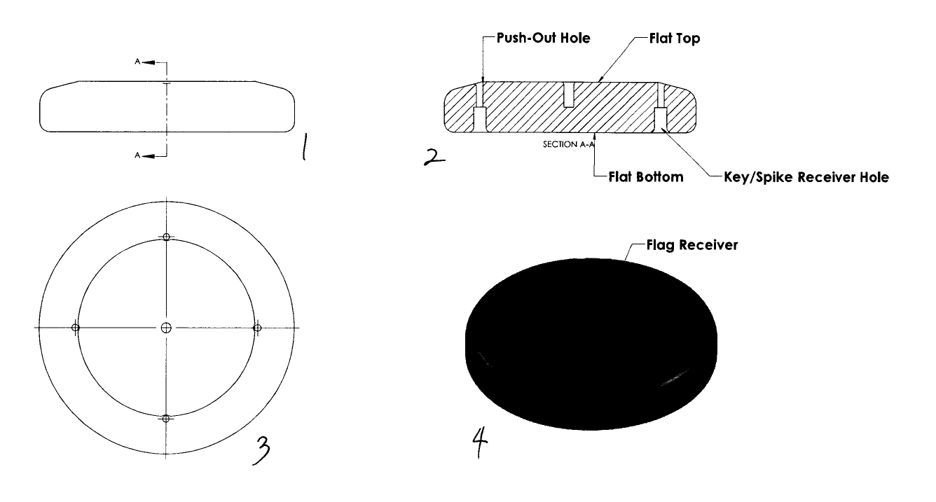

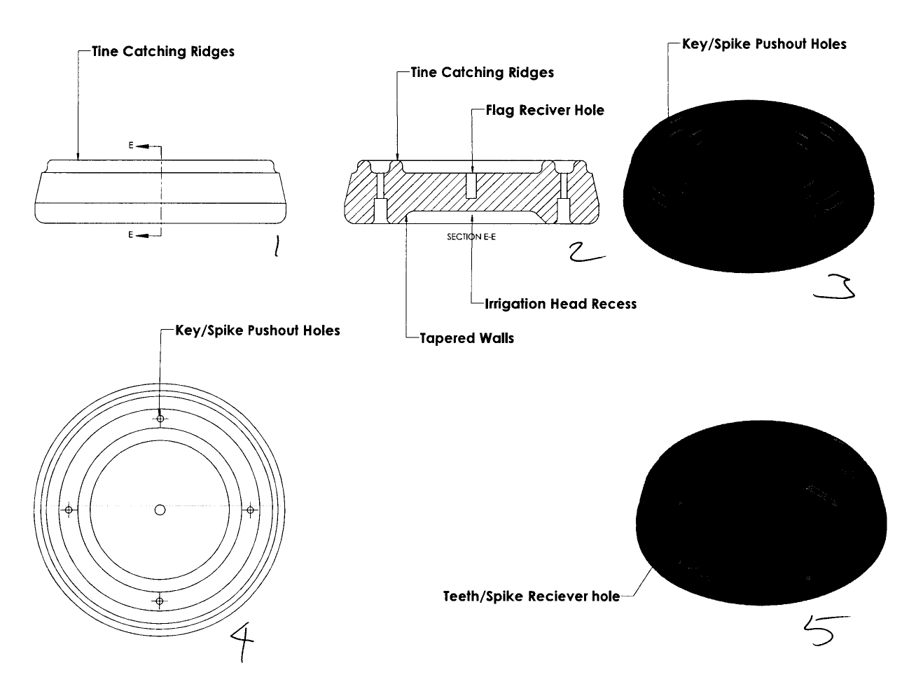

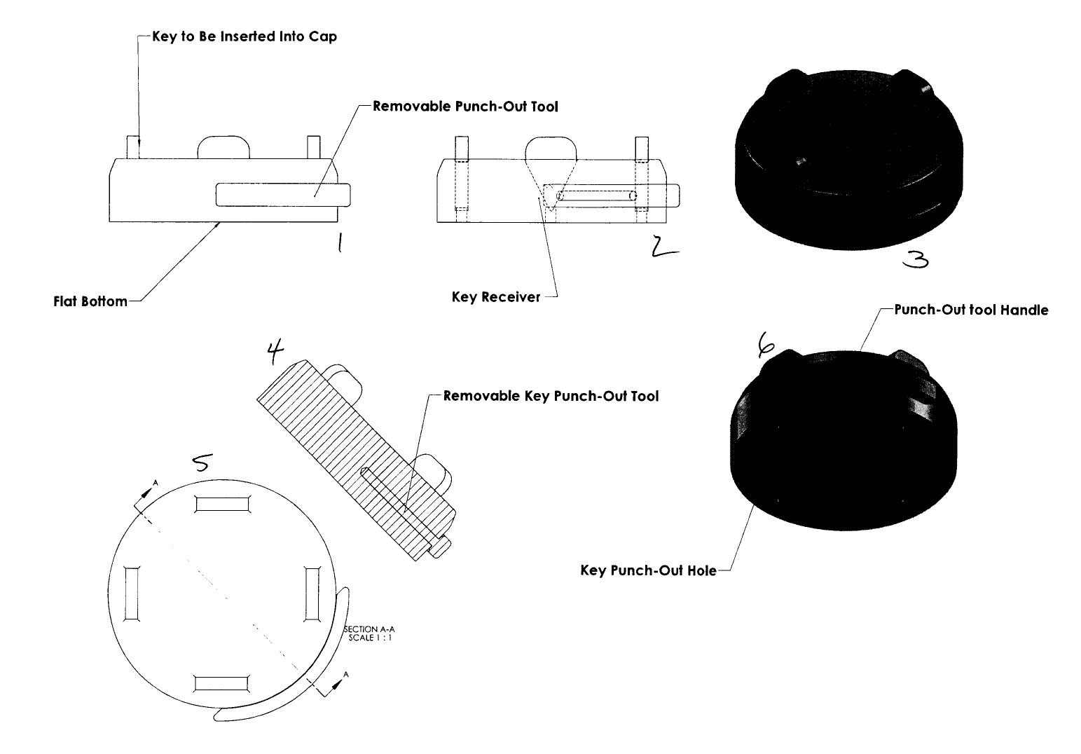

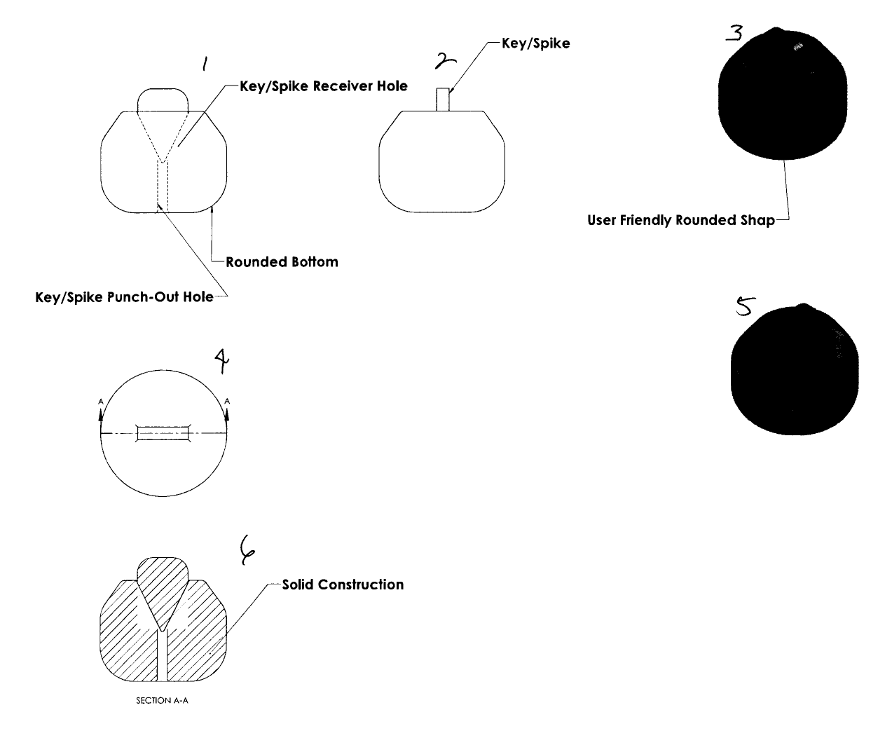

FIG. 5 is an top view of the part illustrating the relationships of the push out holes and flag receiver hole to the top of the device.

FIG. 6 is a bottom view of the device to show the irrigation head recess and Biodegradable Key/Spike receiver holes.

Title—B Drawing No. 2 Descriptions

FIG. 1 is a Cross SECTION A:A view of the temporary protective device assembly with associated parts and how they relate to each other.

FIG. 2 is a front view of the assembly with the hidden lines shown allowing you to see the relationship between the device and the irrigation head.

FIG. 3 illustrates the front of the device with the solid lines showing, this figure it the view that FIG. 1 is cross sectioned from.

FIG. 4 illustrates the bottom view of the assembly.

FIG. 5 and FIG. 6 are views to show the relationship between the associated parts.

Title C—Drawing No.1 Descriptions

FIG. 1 is a bottom view allowing you to see the relationship between the molded spikes and the spike insertion holes.

FIG. 2 is an isometric view that allows many aspects of the device to be shown. The domed low profile top, the insertion points where the spikes would be driven through. The flag receiver hole, you can also see the size relation of the molded spikes protruding out of the bottom.

FIG. 3 is a side view shows the hidden lines which to give reference to the Irrigation head recess. Notice how the flag receiver hole doesn't go completely through the device.

FIG. 4 is an bottom view shows how most of the devices aspects associate with each other.

FIG. 5 shows the angle of the tapered walls of the irrigation head recess. It also shows the angle of the spike insertion holes and the relationship that they have with the molded spikes.

Title-D Drawing No. 1 Descriptions

FIG. 1 is a side view of the device illustrating its molded teeth and has hidden lines to show the irrigation head recess.

FIG. 2 is a cross section view (SECTION A-A) that's allows to notice the solid top and molded teeth.

FIG. 3 is a solid side view.

FIG. 4 is an top view that shows the devices annular shape.

FIG. 4-5 is an isometric and a custom view showing the depth and features of the device.

FIG. 6 and FIG. 7 are bottom angle views that shows the caps recess.

FIG. 8 Is a bottom view.

Title-D Drawing No. 2

FIGS. 1-4 depicts various side views to illustrate the relationship between the device and irrigation head.

FIG. 5 is a section view (SECTION A-A) allowing you to see that the top portion of the device is solid.

Title-D Drawings No. 3

FIG. 1 is a side isometric transparent view of the assembly.

FIG. 2 is a cross section view.

FIG. 3 is a side view.

FIG. 4 is a perspective view.

FIG. 5 is an alternate perspective view.

FIG. 7 is a top view.

Title-E Drawings No. 1

FIG. 1-8.

Title-E Drawings No. 2

FIG. 1-11.

Title-E Drawings No. 3

FIG. 1-9.

Title-E Drawings No. 4

FIG. 1-6.

Title-F Drawings No. 1

FIG. 1 Is a side view/cross sectional of the device.

FIG. 2 is a bottom view of the device.

FIG. 3 is a perspective view of the device.

FIG. 4 is a side view of the device.

FIG. 5 is a perspective view of the device.

FIG. 6 is a bottom view of the device.

Title-F Drawings No. 2

FIG. 1-6.

Title-G Drawings

FIG. 1-4.

Title-H Drawings

FIG. 1-6.

Title-I Drawings No. 1

FIG. 1 is a perspective view of the device.

FIG. 2 is a bottom schematic view.

FIG. 3 is a perspective view of the device.

FIG. 4 is a hidden line schematic view.

FIG. 5 is an alternate schematic side view.

FIG. 6 is an alternate schematic side view.

FIG. 7 is a perspective view of a bottom of the device.

FIG. 8 is a bottom schematic view.

FIG. 8 is a perspective view of the device.

Title-I Drawings No, 2

FIG. 1-9.

Title-I Drawings No, 3

FIG. 1-8.

Title-I Drawings No. 4

FIG. 1-8.

Title-J Drawings

FIG. 1-7.

Title-K Drawing No. 1 Descriptions

FIG. 1 Figure one the bottom view of the device that illustrates the “keyed” or “slide in” type of keys/spikes. You can see the various aspect of this type of way to fasten keys/spikes. Also note that this device is still equipped to take keys/spikes design for the hole receiver type of anchor.

FIG. 2 is a cross section A-A view of key slid into the receiver slide.

FIG. 3 this shows a side view of the temporary device with two keys installed.

FIG. 4 The top view with the hidden lines showing let you realize all of the different aspects of the device. It shows that it can take both the receiver hole type key/spike as well as the slide/key type spike/key.

FIG. 5 Perspective bottom view showing two slide in type keys installed as well as the irrigation component recess.

FIGS. 6 & 7.

Title-L Drawings

FIG. 1-5.

Title-M Drawings

FIG. 1-4.

Title-N Drawings

FIG. 1-5.

Title-P Drawings

FIG. 1-6.

Title-Q Drawings

FIG. 1-6.

### DETAILED DESCRIPTION OF THE INVENTION

Purpose/Need

The purpose of the product is a temporary device and protects irrigation system components prior to aeration services or other services that could physically threaten the irrigation components. Will greatly aid in reducing not only damage to irrigation components but could also potentially decrease possibility of damage to aeration equipment by said components. To give contractors the ability to better market there services, protect themselves from potential damage liabilities, set them apart from the competition, increase their professionalism, and limit the possibility that they may get stuck holding the bag from a prior contractors damage. It will also open doors for additional services “Oh by the way when we were installing your devices we noticed your heads need cleaned, too low, too high, out of alignment etc.”

Installation Procedures

After locating the irrigation component to be protected, the irrigation system needs to be either turned off or going to be non active during the course of the aeration service. Remove a device from your hip bag, insert the four keys as instructed, center the protective device over the irrigation component. Simply push in by straight down force (by foot pressure) or gently installed with rubber mallet. If biodegradable keys have a difficult time piercing the soil or break off in the process this is an indicator that the property is more than likely too dry to properly aerate. A properly installed irrigation head assembly only protrudes approx. ½ inch or less above the soil line, which allows the cap assembly, with its generally beveled inner recess, to safely slide over protruding head surface with limited resistance. Typically on older irrigation installations the head assembly's highest point is found below the surface of the soil, in this event there would be no resistance whatsoever, the device would simply slide across the surface of the turf if impacted by an aeration tine and slid horizontally. Irrigation heads that are higher than manufacturers specified installation height can still be covered If not exceeding the depth of the recess in the center of the device. For improperly installed irrigation components (too high), use the device for marking purposes only or the head could be damage if the device slides horizontally. Once the device is installed over the head properly you are to install the high visibility flag. After the installation of devices is complete in areas to be aerated you are free to begin your service. We recommend that if aerating with riding equipment you adjust your course so as not to hit the device with a wheel/tire prior to the aerator passing over the protective device. Given the design of the device it is unlikely for it to get jammed between aeration tines. In the unlikely event that the device ‘jams’ (carries with aerator tines) and doesn't release and fall out on its own. The operator needs to turn off all power to equipment and remove device manually. These devices are designed to take a beating so just think of the scrapes gouges etc. As a well earned war wound. After aeration process is complete in any given area devices can simply be removed and taken to the next portion of the property in the event that you are servicing a large property.

Product Benefits

This product could be very beneficial to the commercial industry as well as the residential industry; aeration is typically a service that homeowners hire commercial contractors to complete. In the event that the homeowner aerates his own property, the present invention is an affordable method to better protect the irrigation system. It allows for more thorough aeration given that you don't have to swing wide to go around a turf head which leads to substantial swathes that did not get aerated which affects the soils ability to absorb nutrients from fertilization and affects its ability to take in water, which can lead to an uneven greenup/uneven health of turf grass. Aerators are difficult to turn and in the process of turning typically the soil penetration is reduced on one side of the tine assembly or the other. It also makes a walk behind aerator much more labor intensive once again given that aerators are difficult to turn once they are engaged in the soil. The same basic characteristics and benefits can be applied to a tractor mounted 3-point aerator or pull behind aerator. On a three point solid mounted aeration units turning with the tines engaged in the soil can be damaging and highly stressful to the aeration unit itself, not to mention added labor to the operator.

Homeowner benefits-A homeowner could purchase this product and install prior to aeration by themselves or a contractor. Would add confidence while you're at work or away that your irrigation system investment is better protected.

Benefits to irrigation installation professionals—This would be a product that you could sell upon the time of the installation of a system for a homeowner or commercial property to keep on premises for future use. Potential users of the invention are irrigation system installers, power equipment and/or lawn & garden stores, and any company that provides aerations, mowing, property maintenance, and the like.

In the field of horticulture for example, these protective devices could be used in various applications such as temporary protector/marker that could be installed over irrigation heads in areas that a) edging shovel/power edger's are used, b) not intended to be struck/or protect from damage by gas powered edging equipment, c) only to be used for marking purposes as well as re-locating irrigation heads via the flag if buried in the soil, and d) masonry construction/landscape installation in a bed areas/near irrigation components, (in these conditions recommend the use of solids spikes).

Device A Description

Device is constructed of high impact plastic or other materials know to those in the art that is rigid and provide protection to an object from an impact. This device is circular but can be of any shape, with a raised/domed/saucer top and a flat or generally flat bottom. Any shape can be used provided it deflects and/or absorbs impact protecting the irrigation component. Located on the underside of the device there can be a flat or generally flat receiver-less bottom or have one or more female receiver points. In the center of the bottom is an indentation with tapered side walls. Circular Indentation does not extend through the top portion of the device, and its outer perimeter does not extend to the outer bottom edges of the device but is terminated at such a point that it allows for a flat or generally flat outer ring for the placement of the female receiver holes discussed earlier. This also aids in impact/load force displacement. On the top side of the domed device there is at least one small hole located over the female receivers which would allow for the insertion of a rod or punch to be pushed through to remove anything inserted into the receiver hole on the bottom side. Located on the top side of the dome is a partial recess hole that does not penetrate the thickness of the dome. This small hole is for the purpose of the insertion of a location device similar to that of a flag and post assembly. Location device Hole/other means of anchoring, could be located on any portion of the device, or the device could be without a receiver hole. On the bottom side of the device biodegradable keys/spikes or solid keys/spikes could be inserted into the about 90 degree female receiver holes earlier discussed. Receiver hole/holes angle can vary to meet different requirements of the devices performance. Keys will have sufficient length and width for the assembly to be firmly anchored to the ground by means of foot pressure or mallet. When frozen soil applications apply solid (plastic, metal, wood, and various other hard materials) anchoring methods would be necessary due to increased soil resistance.

Device B Description

Device is constructed of high impact plastic or other materials know to those in the art that are rigid and provide protection to an object from impact. This device is circular in shape but can be of any shape, with a flat or generally flat top, gently rolled corners and a flat or generally flat bottom. Any shape can be used provided it deflects and/or absorbs impact protecting the irrigation component. Located on the underside of the device there can be a flat or generally flat receiver-less bottom or have one or more female receiver points. In the center of the bottom is an indentation with tapered side walls. Circular Indentation does not extend through the top portion of the device, and its outer perimeter does not extend to the outer bottom edges of the device but is terminated at such a point that it allows for a flat or generally flat outer ring for the placement of the female receiver holes discussed earlier this also aids in impact force/load displacement. On the top side of the flat or generally flat device there is at least one small hole located over the female receiver which would allow for the insertion for a rod or punch to be pushed through to remove anything inserted into the receiver holes on the bottom side. Located on the top side of the dome is a partial recess hole that does not penetrate the thickness of the flat or generally flat top. This small hole is for the purpose of the insertion of a location device similar to that of a flag and post assembly. Hole/other means of anchoring, could be located on any portion of the domed top of the device, or the device could be without a receiver hole. On the bottom side of the device biodegradable keys/spikes or solid keys/spikes could be inserted into the about 90 degree female receiver holes earlier discussed. Receiver hole/holes angle can vary to meet different requirements of the devices performance. Keys will have sufficient length and width for the assembly to be firmly anchored to the ground by means of foot pressure or mallet. When frozen soil applications apply solid (plastic, metal, wood, and various other hard materials) anchoring methods would be necessary due to increased soil resistance.

Device C Description

Device is constructed of high impact plastic or other materials know to those in the art that are rigid and provide protection to an object from impact. This Device is circular but can be of any shape, with a raised/domed/saucer top and a flat or generally flat bottom. Any shape can be used provided it deflects and/or absorbs impact protecting the irrigation component. In the center of the bottom is an indentation with tapered side walls. Circular Indentation does not extend through the top portion of the device, and its outer perimeter does not extend to the outer bottom edges of the device but is terminated at such a point that it allows for a flat or generally flat outer ring for the placement of the female receiver holes discussed earlier this also aids in impact force displacement. This device has at least one molded spikes located on the fiat or generally flat underside of the device molded to the body as one assembly. These spikes are for the purpose of anchoring the device into the soil, to be applied by foot or mallet. Viewing the device from the top there are one or more holes penetrating the top at about a 45 degree angle, angle can be changed to meet different requirements of the devices performance, existing on the flat or generally flat ring on the underside of the device. These holes can vary in size, they are designed for spikes to be driven or push from the top of the device downward to further help anchor the device to the ground. Ideal for winter use if applied before ground freezes, the spikes can freeze into the soil and hold the device in place for winter protection application. These spikes could be any length or any material. Entering the device from an angle would give the device more resistance if it were being pulled from the soil with these nails engaged. They are at a sufficient angle they would add significant resistance if the device was to be pulled directly upward. Located on the top side of the flat or generally flat top is a partial recess hole that does not penetrate the thickness of the top. This small hole is for the purpose of the insertion of a location device similar to that of a flag and post assembly. Hole/other means of anchoring, could be located on any portion of the domed top of the device, or the device could be without a receiver hole.

Device D

Device is constructed of high impact plastic or other materials know to those in the art that are rigid and provide protection to an object from impact. This device is cylindrical but can be of any shape, with a raised/domed/saucer top. Any shape can be used provided it deflects and/or absorbs impact protecting the irrigation component. On the bottom face of the cylinder is an indentation with generally straight walls. The remaining material of the walls is made in such a fashion as to make one or more key/spikes. These spikes are for the purpose of anchoring the device into the soil, to be applied by foot or mallet. Located on the top side of the dome is a partial recess hole that does not penetrate the thickness of the dome. This small hole is for the purpose of the insertion of a location device similar to that of a flag and post assembly. Hole/other means of anchoring, could be located on any portion of the domed top of the device, or the device could be without a receiver hole.

Device E

Device is constructed of high impact plastic or other materials know to those in the art that are rigid and provide protection to an object from impact. This device generally rectangular or square but can be any shape, with a flat top or generally flat top, gently rolled corners and a flat or generally flat bottom. Any shape can be used provided it deflects and/or absorbs impact protecting the irrigation component. Located on the underside of the device there can be a flat or generally flat receiver-less bottom or are one or more female receiver points. In the center of the bottom is an indentation with tapered side walls. This rectangular or square Indentation does not extend through the top portion of the device, and its outer perimeter does not extend to the outer bottom edges of the device but is terminated at such a point that it allows for a flat or generally flat outer perimeter for the placement of the about 90 degree female receiver holes discussed earlier this also aids in impact force displacement. Receiver hole/holes angle can vary to meet different requirements of the devices performance. On the top side of the flat or generally flat device there is at least one small hole located over the female receivers which would allow for the insertion for a rod or punch to be pushed through to remove anything inserted into the receiver holes on the bottom side. Located on the top side of the flat or generally flat top is a partial recess hole that does not penetrate the thickness of the top. This small hole is for the purpose of the insertion of a location device similar to that of a flag and post assembly. Hole/other means of anchoring, could be located on any portion of the domed top of the device, or the device could be without a receiver hole. Keys will have sufficient length and width for the assembly to be firmly anchored to the ground by means of foot pressure or mallet. If the soil is frozen, solid (plastic, metal, wood, and various other hard materials) anchoring methods would be necessary due to increased soil resistance.

Device F

Device is constructed of high impact plastic or other materials know to those in the art that are rigid and provide protection to an object from impact. This device is circular but can be of any shape with a flat or generally flat top, gently rolled corners and a flat or generally flat bottom. Any shape can be used provided it deflects and/or absorbs impact protecting the irrigation component. Located on the underside of the device there can be a flat or generally flat receiver-less bottom or are one or more female receiver points. In the center of the bottom is an indentation with tapered side walls. Circular Indentation does not extend through the top portion of the device, and its outer perimeter does not extend to the outer bottom edges of the device but is terminated at such a point that it allows for a flat or generally flat outer ring for the placement of the female receiver holes discussed earlier this also aids in impact force displacement. On the top side of the flat or generally flat device there is at least one small hole located over the female receivers which would allow for the insertion for a rod or punch to be pushed through to remove anything inserted into the receiver holes on the bottom side. Located on the top side of the dome is a partial recess hole that does not penetrate the thickness of the dome. This small hole is for the purpose of the insertion of a location device similar to that of a flag and post assembly. Hole/other means of anchoring, could be located on any portion of the domed top of the device, or the device could be without a receiver hole. On the bottom side of the device biodegradable keys/spikes or solid keys/spikes could be inserted into the about 90 degree female receiver holes earlier discussed. Receiver hole/holes angle can vary to meet different requirements of the devices performance. Keys will have sufficient length and width for the assembly to be firmly anchored to the ground by means of foot pressure or mallet. When frozen soil applications apply solid (plastic, metal, wood, and various other hard materials) anchoring methods would be necessary due to increased soil resistance.

Key G

This key can be but not limited to high impact plastic, compressed fertilizer, biodegradable material, combination of materials or other material know to those in the art. Some examples of possible biodegradable materials could be pressed wood, corn polymer, plant starch etc. Any material that can be decomposed by bacteria or other living organisms can be used. This Key/Spike is an anchor that inserts into the device, when the key is in the female receiver hole in the flat or generally flat bottom of the device the portion of the key that extends beyond the bottom of the device can be triangular in shape and can be wider than it is thick. This key can be any shape that completes the performance requirements of anchoring the protect device to the ground. Key could have cutting edges (serrated etc.) to help its ability to penetrate and maintain engagement when forced into the ground. The portion of the key that inserts into the female receiver on the flat or generally flat bottom side of the device can be tapered or flat or generally flat sided with slightly rounded upper corners. This key/spike when inserted is located directly beneath the punch-out hole located on the top of the device. Its engagement can be frictional for easy removal or adhered for semi-permanent placement.

Key H

This key can be but not limited to high impact plastic, compressed fertilizer, biodegradable material, combination of material or other material know to those in the art. Some examples of possible biodegradable materials are could be pressed wood, corn polymer, plant starch etc. Any material that can be decomposed by bacteria or other living organisms. This Key/Spike is an anchor that inserts into the device, when the key is in the female receiver hole in the flat or generally bottom of the device the portion of the key that extends beyond the bottom of the device can be triangular in shape and can be wider than it is thick. This key can be any shape that completes the performance requirements of anchoring the protect device to the ground. Key could have cutting edges (serrated etc.) to help it ability to penetrate and maintain engagement when forced into the ground. The portion of the key that inserts into the female receiver on the flat or generally flat bottom side of the device can be tapered or flat or generally flat sided with slightly rounded upper corners. Incorporated into the key/spike is a sheer point designed to break or sheer when under a predetermined force or stress load. This key/spike when inserted is located directly beneath the punch-out hole accessible located on the top of the device. Its engagement can be frictional for easy removal or adhered for semi-permanent placement.

Device 1

Device is constructed of high impact plastic or other materials know to those in the art that are rigid and provide protection to an object from impact. A portion of this device is circular, but can be of any shape, being terminated by a flat or generally flat side which allows the circular device to be placed flat or generally flat against an object, allowing the circular portion of the device to cover an object. It has a domed top and a flat or generally flat bottom. Any shape can be used provided it deflects and/or absorbs impact protecting the irrigation component. Located on the underside of the device are one or more female receiver points. In the center of the bottom is an indentation with tapered side walls. Circular Indentation does not extend through the top portion of the device, and its outer perimeter does not extend to the outer bottom edges of the device but is terminated at such a point that it allows for a flat or generally flat outer ring for the placement of the female receiver hole discussed earlier this also aids in impact force displacement. The terminated flat or generally flat side has a flat or generally flat face around the indentation that allows force to be displaced when place against a flat or generally flat object. On the top side of the domed device there is at least one small hole located over the female receivers which would allow for the insertion for a rod or punch to be pushed through to remove anything inserted into the receiver holes on the bottom side. Located on the top side of the dome is a partial recess hole that does not penetrate the thickness of the dome. This small hole is for the purpose of the insertion of a location device similar to that of a flag and post assembly. Hole/other means of anchoring, could be located on any portion of the domed top of the device, or the device could be without a receiver hole. On the bottom side of the device biodegradable keys/spikes or solid keys/spikes could be inserted into the about 90 degree female receiver holes earlier discussed. Receiver hole/holes angle can vary to meet different requirements of the devices performance. Keys will have sufficient length and width for the assembly to be firmly anchored to the ground by means of foot pressure or mallet. When frozen soil applications apply solid (plastic, metal, wood, and various other hard materials) anchoring methods would be necessary due to increased soil resistance.

Type I Device Description

The Type I device is basically a variant of the Type A device but it is designed to have the open face of the temporary protective device mate with an object that may have been to close for the original Type A device to fit. A good example of this would be if an irrigation component was next to a curb or sidewalk, the Type A devices circumference would not allow it to fit between the component and the curb/sidewalk while maintaining flat or generally flat contact with the ground. The Type I open face would allow it to productively cover the irrigation component while maintaining flat or generally flat contact with the ground.

Device J

Device is constructed of high impact plastic or other materials know to those in the art that are rigid that provides protection to an irrigation component from impact. A portion of this device is circular, but can be of any shape, being terminated by a flat or generally flat side which allows the circular device to be placed flat or generally flat against an object, allowing the circular portion of the device to cover an object. Any shape can be used provided it deflects and/or absorbs impact protecting the irrigation component. In the center of the bottom is an indentation with tapered side walls. Circular Indentation does not extend through the top portion of the device, and its outer perimeter does not extend to the outer bottom edges of the device but is terminated at such a point that it allows for a flat or generally flat outer ring for the placement of the female receiver holes discussed earlier this also aids in impact force displacement. The terminated flat or generally flat side has a flat or generally flat face around the indentation that allows force to be displaced when placed against a flat or generally flat object. This device has at least one molded spikes/spikes located on the flat or generally flat underside of the device molded to the body as one assembly. These spikes are for the purpose of anchoring the device into the soil, to be applied by foot or mallet. Viewing the device from the top there holes are penetrating the top at approximately an about 45 degree, angle can be changed to meet different requirements to the devices performance, exiting on the flat or generally flat ring on the underside of the device. These holes can vary in size, they are designed for spikes to be driven or push from the top of the device downward to further help anchor the device to the ground. Length of spike would be determined by anchoring requirements to achieve the performance needs of the application and can be made of any material. Entering the device from an angle would give the device more resistance if it were being pulled from the soil with these nails/spikes engaged. Located on the top side of the flat or generally flat top is a partial recess hole that does not penetrate the thickness of the top. This small hole is for the purpose of the insertion of a location device similar to that of a flag and post assembly. Hole/other means of anchoring, could be located on any portion of the domed top of the device, or the device could be without a receiver hole.

Device K

Device is constructed of high impact plastic or other materials know to those in the art that are rigid and provide protection to an object protecting the irrigation component from impact. This device is circular in shape with a flat or generally flat top, gently rolled corners and a flat or generally flat bottom. Any shape can be used provided it deflects and/or absorbs impact protecting the irrigation component. Located on the side of the device are one or more horizontal keyways molded into the outer side wall of the body. Allowing anchor keys to be slid in horizontally and held in place by friction for easy removal or adhesion for semi-permanent anchoring. These keyways can be of any angle that fulfills the performance needs of the device. In the center of the bottom is an indentation with tapered side walls. Circular Indentation does not extend through the top portion of the device, and its outer perimeter does not extend to the outer bottom edges of the device but is terminated at such a point that it allows for a flat or generally flat outer ring for the placement of the horizontally keyways discussed earlier this also aids in impact force displacement. On the top side of the flat or generally flat device there is at least one small hole located over the female receivers which would allow for the insertion for a rod or punch to be pushed through to remove anything inserted into the receiver holes on the bottom side. Located on the top side of the dome is a partial recess hole that does not penetrate the thickness of the dome. This small hole is for the purpose of the insertion of a location device similar to that of a flag and post assembly. Hole/other means of anchoring, could be located on any portion of the domed top of the device, or the device could be without a receiver hole. On the side of the device biodegradable keys/spikes or solid keys/spikes could be inserted into the horizontal keyways earlier discussed. Keys will have sufficient length and width for the assembly to be firmly anchored to the ground by means of foot pressure or mallet. When frozen soil applications apply solid (plastic, metal, wood, and various other hard materials) anchoring methods would be necessary due to increased soil resistance.

Key L

This key can be but not limited to high impact plastic, compressed fertilizer, biodegradable material, combination of materials or other material know to those in the art. Some examples of possible biodegradable materials are could be pressed wood, corn polymer, plant starch etc. Any material that can be decomposed by bacteria or other living organisms. This Key/Spike is an anchor that slides horizontally into the device, when the key is in the horizontal receiver hole in the side of the device the portion of the key that extends beyond the bottom of the device can be triangular in shape and is wider than it is thick. This key can be any shape the completes the performance requirements of anchoring the protect device to the ground Key could have cutting edges (serrated etc.) to help it ability to penetrate and maintain engagement when forced into the ground. The portion of the key that inserts into the horizontal keyway on the side of the device can be a variety of shapes that will serve the purpose of anchoring the spike/key to the device. There can be incorporated into the key/spike a sheer point designed to break or sheer when under a predetermined force or stress load. Its engagement can be frictional for easy removal or adhered for semi-permanent placement.

Device M

Device is constructed of high impact plastic or other materials know to those in the art that are rigid and provides protection to an object from impact. This device is circular but can be of any shape, with a flat or generally flat top incorporates one or more circular ridges that extrude from the top of the device. These ridges help improve the force resistant capabilities of the device. Device could also have patterns or any type of textured surface. The bottom of the device is flat or generally flat. Located on the underside of the device there can be a flat or generally flat receiver-less bottom or are one or more female receiver points. The shape of the top and bottom portions of the device corresponds with it's performance requirements and can be any shape that best protects the component. In the center of the bottom is an indentation with tapered side walls. Circular Indentation does not extend through the top portion of the device, and its outer perimeter does not extend to the outer bottom edges of the device but is terminated at such a point that it allows for a flat or generally flat outer ring for the placement of the female receiver holes discussed earlier this also aids in impact force displacement. On the top side of the flat or generally flat device there is at least one small hole located over the female receivers which would allow for the insertion for a rod or punch to be pushed through to remove anything inserted into the receiver holes on the bottom side. Located on the top side of the dome is a partial recess hole that does not penetrate the thickness of the dome. This small hole is for the purpose of the insertion of a location device similar to that of a flag and post assembly. Hole/other means of anchoring, could be located on any portion of the domed top of the device, or the device could be without a receiver hole. On the bottom side of the device biodegradable keys/spikes or solid keys/spikes are inserted into the about 90 degree female receiver holes earlier discussed. Receiver hole/holes angle can vary to meet different requirements of the devices performance. Keys will have sufficient length and width for the assembly to be firmly anchored to the ground by means of foot pressure or mallet. When frozen soil applications apply solid (plastic, metal, wood, and various other hard materials) anchoring methods would be necessary due to increased soil resistance.

Device N

Device is constructed of high impact plastic or other materials know to those in the art that are rigid and provide protection to an object from impact. Device is circular in shape with a flat or generally flat top, gently rolled corners and a flat or generally flat bottom. Located on the flat or generally flat underside of the device are one or more female receiver points, this flat bottom also aids in impact force displacement. Located on the top side of the dome is a partial recess hole that does not penetrate the thickness of the flat or generally flat top. This small hole is for the purpose of the insertion of a location device similar to that of a flag and post assembly. Hole could be located on any portion of the flat or generally flat top of the device, or the top could be without a receiver hole. On the bottom side of the device biodegradable keys/spikes or solid keys/spikes could be inserted into the female receiver holes earlier discussed. Keys will have sufficient length and width for the assembly to be firmly anchored to the ground by means of foot pressure or mallet.

Tool P (Fast Loader)

This tool is to provide quick and easy installation of spikes/keys into the bottom side of a temporary protective device. The end of the spike that engages the soil is inserted to a recess in the top of the tool; the recesses have the same placement pattern as the device. Once the keys are inserted into the tool, the device is placed on top of the tool, they are pressed together. When the tool assembly is pulled away the keys/spikes are firmly positioned into the device. This allows for quick and easy loading. The tool also houses associated tools for the removal of keys etc. Tool could also have removable bottom section for additional key storage and so forth.

Tool is cylindrical in shape and is molded of high impacted plastic or other materials. The top and bottom surfaces are flat or generally flat. Located in the flat or generally flat top surface are at least one receiver hole that will accept the portion of an anchor spike that would be inserted into the soil, the recesses have the same placement patter as the device allowing the device and the tool to mate. The tool holds the spikes loosely allowing the device to easily pull keys/spikes free of the tool. Once the key is inserted into the device the friction fit would allow the key to stay with the device and pull out of the tool. This surface could also have a center armature for less material requirements. The flat or generally flat bottom side of the tool has holes that correspond with the top key receiver holes allowing for the insertion of the punch-out tool in the event that the key can't be removed by conventional methods. Located on the side wall of the tool is a hole for placement and storage of a punch-out tool that can be used to remove any anchor on both the tool as well as the device by use of the incorporated punch-out holes. The tool could also house other tools/additional keys/etc. In the event that the key/spike were to jam in the tool there is a punch-out hole incorporated into the top to allow for easy removal. The tool could also house other tools/additional keys/etc.

Tool Q

This tool is to provide quick and easy installation of spikes/Keys into the bottom side of a temporary protective device. The end of the spike that engages the soil is loosely inserted to a recess in the top of the tool, allowing the user to hold onto the tool while placing the key into the device receiver hole. This allows for easier and quicker insertions of the keys. Once the key is inserted into the device the friction fit would allow the key to stay with the device and pull out of the tool. The tool could also house other tools/additional keys/etc. In the event that the key/spike were to jam in the tool there is a punch-out hole incorporated into the top to allow for easy removal. The tool could also house other tools/additional keys/etc.

This tool could be constructed of constructed of a high impact plastic or other material. It is somewhat egg like in shape. On one end is a receiver hole that will accept the portion of an anchor spike that would be inserted into the soil. On the top side it is slightly domed to comfortably fit into the palm of your hand when you're applying pressure to insert the key/spike into the receiver hole onto the flat or generally flat bottom side of a device. In the event that the key/spike were to jam in the tool there is a punch-out hole incorporated into the top to allow for easy removal.

Additional Information:
Device could be constructed out of aluminum/metal material.
Device can be constructed of a biodegradable material such as compressed wood, plant (corn) starch/polymers.
Device itself can be constructed of a biodegradable material or combination of materials such as compressed wood, plant starch, corn starch/polymers, compressed fertilizer and other bio materials know those skilled in the art.
Layer or layers of energy absorbing material such as bubble wrap (rubber, Styrofoam, etc.) could be applied between the component being protected and the device itself or could be adhered, mounted or friction fit directly to the underside of the device.

The above specification, example and data provide a complete description of the manufacture and use of the composition of the invention. Since many embodiments of the invention can be made without departing from the spirit and scope of the invention, the invention resides in the claims hereinafter appended.

The foregoing description of the invention has been presented for purposes of illustration and description. It is neither intended to be exhaustive nor to limit the invention to the precise form disclosed. Many alternatives, modifications, and variations will be apparent to those skilled in the art. For example, the terms: cap, key, spike, round, square, and the like, are not meant to limit the overall invention. Such terms can include modifications or combination with other methods and the like. While protection is a major application of this invention, other applications are possible. Accordingly, this invention is intended to embrace all alternatives, modifications, and variations that fall within the spirit and broad scope of the claims.

We claim:

1. A temporary protective device for a sprinkler head connected to an in-ground irrigation system comprising a cover with a generally flat bottom, the cover comprising one or more receiver holes, the receiver holes accepting a removable key, the key anchoring the cover over the sprinkler head and extending into the ground below the receiver hole.

2. The device of claim 1 wherein the key is releasable when a predetermined stress is applied.

3. The device of claim 1 wherein the key is biodegradable.

4. The device of claim 1 wherein the cover is biodegradable.

5. The device of claim 1 wherein a top of the cover is dome-shaped.

6. The device of claim 1 wherein the bottom comprises a recess, the recess sized to accept the sprinkler head top.

7. The device of claim 6 further comprising a cushion, the cushion located above the recess and a top of the cover.

8. The device of claim 1 wherein a top of the cover comprises an opening, the opening shaped to hold an end of a flag.

9. The device of claim 1 wherein the cover comprises a receptacle to store the key.

10. A temporary protective device for a sprinkler head connected to an in-ground irrigation system comprising a cover with a generally flat bottom, the cover comprising one or more keys extending from the bottom of the cover, the keys anchoring the cover over the sprinkler head and extending into the ground.
